(19) United States
(12) Patent Application Publication
(10) Pub. No.: US 2026/0051140 A1
(43) Pub. Date: Feb. 19, 2026

(54) PRODUCTION LINE CONFORMANCE MEASUREMENT TECHNIQUES USING INTELLIGENT OPTIMIZATION OF MODEL INPUT DATA FOR A MACHINE LEARNING DETECTION MODEL

(71) Applicant: Optum, Inc., Minnetonka, MN (US)

(72) Inventors: Colby A Wright, Chandler, AZ (US); Thomas R Gilbertson, Cromwell, CT (US); Haylea Tricia Porter, Simsbury, CT (US); Raja Mukherji, Dublin (IE); Connor David Fergesen, Minneapolis, MN (US); Karen M Harte, Avon, CT (US)

(21) Appl. No.: 18/802,376

(22) Filed: Aug. 13, 2024

(51) Int. Cl. G06V 10/26; G06T 7/13; G06T 7/62; G06V 10/44; G06V 10/774

(52) U.S. Cl. CPC G06V 10/273; G06T 7/13; G06T 7/62; G06V 10/44; G06V 10/774; G06T 2207/20081; G06T 2207/30108

(57) ABSTRACT

Various embodiments of the present disclosure provide production line conformance measurement techniques using intelligent optimization of model input data for a machine learning detection model. The techniques may include generating a cropped image from a production line image based on an outer circumference associated with a production line item, generating a derivative cropped image from the cropped image based on an interior circumference associated with the production line item, generating a transformed input image from the derivative cropped image based on one or more model parameters of a machine learning detection model, and generating, using the machine learning detection model, a prediction output based on the transformed input image.

### BACKGROUND

Various embodiments of the present disclosure address technical challenges related to image-based prediction techniques, such as those used in the performance of production line conformance monitoring. Traditional image-based prediction techniques for production line conformance monitoring may employ machine learning models that are trained to generate predictions based on images taken on a production line. As such, the predictions output by such models may be dependent on a plurality of aspects of the image, such as an orientation, lighting, noise, and/or the like that may change depending on the attributes of the imaged object. This, in turn, causes performances deficiencies, such as false negatives, for a respective machine learning model due to different object attributes, such as a fill level for a pill container. Various embodiments of the present disclosure make important contributions to traditional image-based prediction techniques by addressing these technical challenges, among others.

### BRIEF SUMMARY

Various embodiments of the present disclosure provide image processing techniques that improve traditional image-based prediction techniques, such as those used in the performance of production line conformance monitoring. To do so, embodiments of the present disclosure provide production line conformance measurement techniques using intelligent optimization of model input data for a machine learning detection model. Some embodiments of the present disclosure provide methods, apparatus, systems, computing devices, computing entities, and/or the like for production line conformance monitoring that leverage improved input data processing for categorical validation machine learning models generated using a plurality of training production line images associated with a related category subset of a plurality of validation categories for a target validation category. Some embodiments of the present disclosure improve the accuracy, reliability, and coverage of such models using various image processing techniques. For example, some techniques of the present disclosure may improve performance of machine learning models by improving quality and/or optimally formatting of images provided to the machine learning models to account for predefined object attributes, such as fill level, that may cause anomalous model outputs. By doing so, more accurate predictions related to a target validation category related to a machine learning model may be provided. Moreover, a number of computing resources for providing predictions via machine learning may be reduced.

In some embodiments, a computer-implemented method includes generating, by one or more processors, a cropped image from a production line image based on an outer circumference associated with a production line item. In some embodiments, the computer-implemented method additionally or alternatively includes generating, by the one or more processors, a derivative cropped image from the cropped image based on an interior circumference associated with the production line item. In some embodiments, the computer-implemented method additionally or alternatively includes generating, by the one or more processors and by applying a geometric transformation function, a transformed input image from the derivative cropped image based on one or more model parameters of a machine learning detection model. In some embodiments, the computer-implemented method additionally or alternatively includes generating, by the one or more processors and using the machine learning detection model, a prediction output based on the transformed input image. In some embodiments, the computer-implemented method additionally or alternatively includes initiating, by the one or more processors, the performance of one or more prediction-based actions based on the prediction output.

In some embodiments, a computing system includes memory and one or more processors communicatively coupled to the memory. In some embodiments, the one or more processors are configured to generate a cropped image from a production line image based on an outer circumference associated with a production line item. In some embodiments, the one or more processors are additionally or alternatively configured to generate a derivative cropped image from the cropped image based on an interior circumference associated with the production line item. In some embodiments, the one or more processors are additionally or alternatively configured to generate, by applying a geometric transformation function, a transformed input image from the derivative cropped image based on one or more model parameters of a machine learning detection model. In some embodiments, the one or more processors are additionally or alternatively configured to generate, using the machine learning detection model, a prediction output based on the transformed input image. In some embodiments, the one or more processors are additionally or alternatively configured to initiate the performance of one or more prediction-based actions based on the prediction output.

In some embodiments, one or more non-transitory computer-readable storage media include instructions that, when executed by one or more processors, cause the one or more processors to generate a cropped image from a production line image based on an outer circumference associated with a production line item. In some embodiments, the instructions, when executed by the one or more processors, additionally or alternatively cause the one or more processors to generate a derivative cropped image from the cropped image based on an interior circumference associated with the production line item.

In some embodiments, the instructions, when executed by the one or more processors, additionally or alternatively cause the one or more processors to generate, by applying a geometric transformation function, a transformed input image from the derivative cropped image based on one or more model parameters of a machine learning detection model. In some embodiments, the instructions, when executed by the one or more processors, additionally or alternatively cause the one or more processors to generate, using the machine learning detection model, a prediction output based on the transformed input image. In some embodiments, the instructions, when executed by the one or more processors, additionally or alternatively cause the one or more processors to initiate the performance of one or more prediction-based actions based on the prediction output.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a dataflow diagram showing example data structures and modules for generating predictions from a production line image in accordance with some embodiments discussed herein.

FIG. 4 is a flowchart diagram of an example process for generating a categorical validation machine learning model for a target validation category in accordance with some embodiments discussed herein.

FIG. 5 is a flowchart diagram of an example process for generating a plurality of training production line images in accordance with some embodiments discussed herein.

FIG. 6 provides an operational example of a radio frequency controlled container in a production line in accordance with some embodiments discussed herein.

FIG. 7A provides an operational example of a production line image in accordance with some embodiments discussed herein.

FIG. 7B provides an operational example related to one or more image cropping and/or image formatting processes for a production line image in accordance with some embodiments discussed herein.

FIG. 8 is a flowchart diagram of an example process for performing one or more data augmentation operations on a set of transformed training production line images to update the set of transformed training production line images in accordance with some embodiments discussed herein.

FIG. 9 is a flowchart diagram of an example process for updating parameters of a categorical validation machine learning model based on a transformed training production line image in accordance with some embodiments discussed herein.

FIG. 10 is a flowchart showing an example process for selectively, intelligently, and optimally preprocessing data for a machine learning detection model in accordance with some embodiments discussed herein.

FIG. 11 is a flowchart diagram of an example process for performing one or more prediction-based actions based on a validation prediction for an input production line image with respect to a target validation category in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

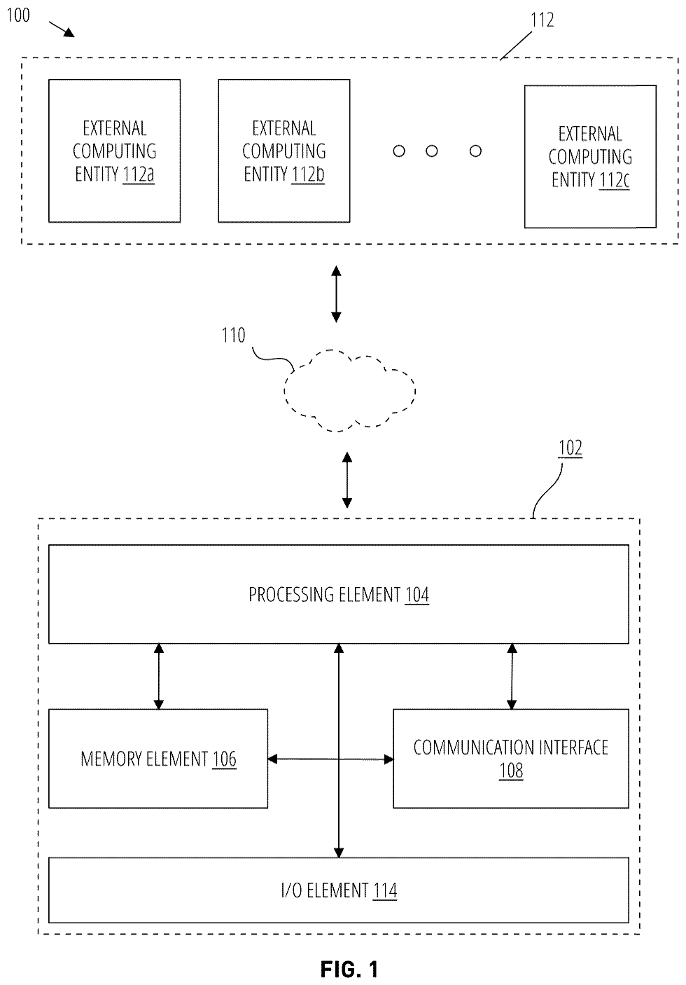

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., production line conveyance techniques, prediction techniques, training techniques, and/or the like) described herein.

The external computing entities 112a-c, for example, may include and/or be associated with one or more entities that may be configured to receive, store, manage, and/or facilitate datasets, such as the training dataset, imaging dataset, process control database, and/or the like. The external computing entities 112a-c may provide such datasets, and/or the like to the predictive computing entity 102 which may leverage the datasets to generate validation predictions, prediction-based action control instructions, and/or the like, as described herein. In some examples, the datasets may include an aggregation of data from across the external computing entities 112a-c into one or more aggregated datasets. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a prediction domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

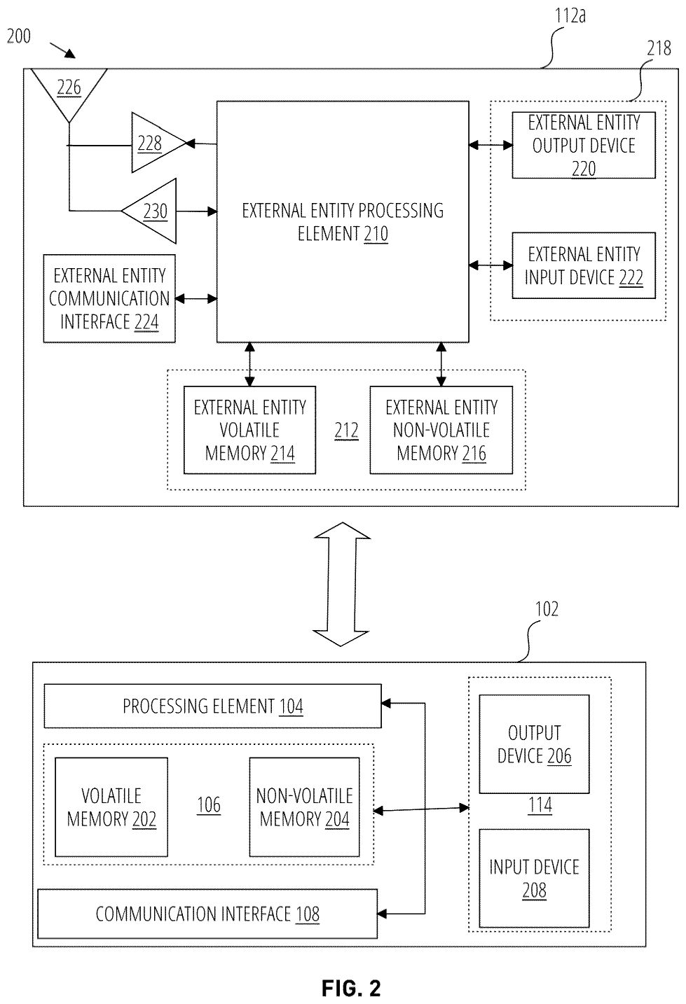

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product which includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. EXAMPLES OF CERTAIN TERMS

In some embodiments, the term “production line image” refers to a data entity that describes an image captured at a location on a production line. The production line image, for example, may be captured by a camera located relative to (e.g., above, etc.) the location and configured to capture an image of a production line item on a production line as the production line item passes the location. An example of a production line item on a production line is a to-be-filled prescription progressing along steps of a production line in a radio frequency (RF)-controlled container called a puck, where inside the puck may be a pill bottle, and where a pharmacy production line software may, via the RF signals, control the progress of each puck. In some examples, if the production control equipment and software detect an error with the production line item (e.g., the pill bottle is significantly underweight, meaning it was not filled completely, etc.), the software may generate an exception and physically route the puck to a human for further inspection and/or resolution. In today's commercial pharmacy world, overhead images may be taken of each pill bottle and stored before they are capped and shipped. The production line image may include an overhead image that depicts an overhead view of pill bottle before the pill bottle is capped and dispatched for delivery to an end user, such as a pharmacy, individual, and/or the like.

In some embodiments, a plurality of production line images is captured by a plurality of different cameras positioned at various different locations of a production line. In some examples, one or more of the production line images may processed, using some of the techniques of the present disclosure, to detect an error associated with a production line item. In some examples, at least a portion of the production line images may be assigned a ground-truth label and stored as a plurality of training production line images. As described herein, the ground-truth label for each training production line image may identify a validation category and a validation result for a training production line image.

In some embodiments, a production line image is associated with one or more image attributes. Examples of image attributes may include an object identifier and one or more physical production attributes. An example of an object identifier may be a drug type identifier (e.g., a National Drug Code (NDC) identifier, etc.) for an object, such as a pill capsule (e.g., assigned to a puck container, a pill bottle, etc. that is imaged by a production line image, etc.). A physical production attribute may describe any property associated with the production line item reflected by a production line image. Examples of physical production attributes include a site identifier associated with a pharmacy site of a production line item, a fill line number associated with a fill line of a production line item, a camera identifier for a camera device used to capture a production line image of a production line item, attributes describing one or more camera/flash settings for a camera device used to capture a production line image of a production line item, attributes describing date and/or time of capture of a production line image of a production line item, and/or the like.

In some embodiments, the term “validation category” refers to a data entity that describes a category defined by a subset of image attributes, where validation predictions are generated with respect to the validation category. For example, a validation prediction may be generated with respect to a particular drug type identifier (e.g., NDC), where the validation predictions may describe whether corresponding production line images depict objects associated with the drug type identifier. As another example, validation predictions may be generated with respect to a particular drug type identifier and a particular site identifier, where the validation predictions may describe whether corresponding production line images depict objects associated with the drug type identifier that are generated at the particular site identifier. As yet another example, validation predictions may be generated with respect to a particular drug type identifier, a particular site identifier, and a particular fill line number, where the validation predictions may describe whether corresponding production line images depict objects associated with the drug type identifier that are generated at the particular fill line number of the particular site identifier. In general, any combination of one or more defined image attributes may be used to characterize a validation category.

In some embodiments, the term “training dataset” refers to input data provided to a machine learning model during one or more training stages for the machine learning model to train and/or configure the machine learning model to perform a prediction, inference, labeling, and/or classification task based on the particular domain for the machine learning model. The type, format, and/or parameters of the training dataset may be based on the particular domain for the machine learning model. In various embodiments, the training dataset includes labeled data and unlabeled data. In various embodiments, a training dataset for a particular categorical validation machine learning model includes a plurality of training production line images related to a validation category associated with the categorical validation machine learning model. As described herein, in some examples, a training dataset may be defined differently for one or more initial training operations and/or one or more training operation.

In some embodiments, the term “production line site” refers to a location of a machine learning model (e.g., a categorical validation machine learning model) implemented at a production line. A production line site may be a physical location such as a geographical location, an enterprise location, a location of a production line within a production facility, a warehouse location, or another type of physical location in which a production line is located. In some embodiments, a production line site includes a camera device and/or other components to facilitate providing input data to a machine learning model.

In some embodiments, the term “object” refers to a physical object that is produced, sorted, packaged, and/or distributed at a production line site. In some embodiments, an object is a pill capsule. In some embodiments, an object is contained in a production line item such as, for example, a vial or pill container.

In some embodiments, the term “machine learning detection model” refers to a data construct that describes parameters, hyperparameters, coefficients, and/or defined operations to provide one or more predictions, inferences, labels, and/or classifications related to an input dataset. In various embodiments, the machine learning detection model utilizes one or more machine learning techniques using parameters, hyperparameters, and/or defined operations. A machine learning detection model may include one or more of any type of machine learning detection model including one or more supervised, unsupervised, semi-supervised, reinforcement learning models, and/or the like. In some examples, a machine learning detection model may include multiple models configured to perform one or more different stages of a prediction, inference, and/or classification process.

In some embodiments, the machine learning detection model is a neural network, a deep learning model, a convolutional neural network model, a classification model, a logistic regression model, a decision tree, a random forest, support vector machine (SVM), a Naïve Bayes classifier, and/or any other type of machine learning detection model. For instance, the machine learning detection model may include one or more rule-based layers that depend on trained parameters, hyperparameters, coefficients, defined operations, and/or the like. In some examples, the machine learning detection model is trained (e.g., by updating the one or more parameters, and/or the like) using one or more semi-supervised training techniques. In some examples, a configuration, type, and/or other characteristics of the machine learning detection model may be dependent on the particular domain. In various embodiments, the machine learning detection model is trained, using a training dataset, to generate a classification (and/or probability thereof) for a particular domain.

In some embodiments, a machine learning detection model is a categorical validation machine learning model. For example, in some embodiments, the machine learning detection model refers to a data entity that is configured to describe parameters, hyper-parameters, and/or defined operations of a machine learning model that is configured to determine whether an input production line image corresponds to a target validation category that is associated with the machine learning detection model. In some embodiments, the machine learning detection model is configured to process at least one of the production line image (e.g., as a matrix), extracted image-based features values associated with the input production line image (e.g., as a vector), and/or one or more physical production attributes for the input production line image (e.g., as a vector), in order to determine a validation prediction for the input production line image that describes whether an input production line image corresponds to a target validation category that is associated with the machine learning detection model.

In some embodiments, the machine learning detection model includes a convolutional neural network, such as a binary classification convolutional neural network, that is characterized by at least one (i) five layers including four two-dimensional convolutional layers and one flattening layer, (ii) filters that are increased across the two-dimensional convolutional layers to capture patterns and details in the input image, and/or (iii) each 2-dimensional convolutional layer utilizes a rectified linear unit (ReLU) activation function. In some embodiments, each two-dimensional convolution operation in a two-dimensional convolutional layer is followed by a pooling operation (e.g., with a size and stride of two), where dropout values are increased across two dimensional convolutional layers to a maximum value (e.g., a maximum value of 0.7). In some embodiments, the machine learning detection model is trained using a binary cross-entropy loss function, with constant label smoothing (e.g., constant label smoothing at 0.1 to train the model with mislabeled data and with improved overall robustness and accuracy). In some embodiments, to train the machine learning detection model, an optimization function such as Adam Optimizer function or a Stochastic gradient descent optimizer function is utilized. While various embodiments of the present disclosure describe that the machine learning detection model includes a convolutional neural network, a person of ordinary skill in the relevant technology will recognize that any machine learning model (e.g., any neural network, such as any pre-trained neural network) may be utilized as part of the machine learning detection model.

In some embodiments, the term “prediction output” refers to a data construct that describes one or more prediction insights, classifications, and/or inferences provided by one or more machine learning models. In various embodiments, prediction insights, classifications, and/or inferences may be with respect to a production line image. In certain embodiments, a prediction output may provide a validation prediction as to whether a corresponding production line image that is associated with the validation prediction is associated with a corresponding validation category.

In some embodiments, the term “validation prediction” refers to a data entity that is configured to describe a conclusion about whether a corresponding production line image that is associated with the validation prediction is associated with a corresponding validation category. For example, the validation prediction may describe (i) a likelihood that a corresponding production line image that is associated with the validation prediction describes an object for a validation category that is associated with the validation prediction, (ii) a likelihood that a corresponding production line image that is associated with the validation prediction does not describe an object for a validation category that is associated with the validation prediction, and/or the like. By way of example, a validation prediction may include a prediction score indicative of an affirmative and/or negative category likelihood. The prediction score may include a binary number (e.g., 0 or 1), a numerical range, a ratio, a percentage, and/or the like. In some examples, the prediction score may include a number between zero and one.

In some embodiments, a validation prediction describes at least one of an affirmative category likelihood for the production line image and/or a negative category likelihood for the production line image. In some embodiments, a validation prediction describes at least one of a smoothed affirmative likelihood for the production line image and/or a smoothed negative category likelihood for the production line image. An affirmative category likelihood may describe a value generated by the machine learning detection model that describes a likelihood that an input image provided as an input to the machine learning detection model (e.g., during training, a training production line image) corresponds to a validation category associated with the machine learning detection model. A negative category likelihood may describe a value generated by the machine learning detection model that describes a likelihood that an input image provided as an input to the machine learning detection model (e.g., during training, a training production line image) does not correspond to a validation category associated with the machine learning detection model. In some embodiments, the affirmative category likelihood and/or the negative category likelihood are processed using a likelihood smoothing transformation to determine a smoothed affirmative likelihood and/or a smoothed negative category likelihood.

In some embodiments, determining the validation prediction includes determining an initial validation score based on one or more outputs of the machine learning detection model; determining an adjusted validation score based on adjusting the initial validation score using a false positive penalty weight and a false negative penalty weight; and determining the validation prediction based on the adjusted validation score.

In some embodiments, the term “process control database” refers to a set of one or more data entities (e.g., a set of data entities stored in a distributed manner) that contain data for a database that describes, for each validation category of a set of defined validation categories, a action threshold for the validation category and the one or more process control parameters for the validation category, where the action threshold for the validation category may describe a condition that, when satisfied by the validation prediction for a production line image with respect to the validation category, causes performance of one or more production line control actions based on one or more process control parameters associated with the validation category. For example, the action threshold may recommend that, when a validation prediction for a production line image with respect to a corresponding validation category exceeds a particular numeric value, the one or more production line control actions for the corresponding validation category should be performed. As another example, the action threshold may recommend that, when a validation prediction for a production line image with respect to a corresponding validation category falls below a particular numeric value, the one or more production line control actions for the corresponding validation category should be performed.

In some embodiments, the process control database may describe, for each validation category of a set of defined validation categories, specific image transformation requirements and measurement parameters associated with the validation category, such as properties associated with the crop, enhancement, and measurement transformations for the validation category. In some embodiments, the process control database may describe data associated with each validation category in a row of a relational database, where the row is associated with the validation category. In some embodiments, the process control database may describe data associated with each validation category in a column of a relational database, where the column is associated with the validation category.

In some examples, a process control database may define a hierarchical threshold scheme. The hierarchical threshold scheme may define a plurality of action thresholds, each corresponding to a particular prediction-based action associated with a production line. For instance, the hierarchical threshold scheme may define a first action threshold for a first prediction-based action as a first numerical value, range, etc. that, if achieved by a validation prediction may cause a performance of the first prediction-based action. In addition, or alternatively, the hierarchical threshold scheme may define a second action threshold for a second prediction-based action as a second numerical value, range, etc. that, if achieved by a validation prediction may cause a performance of the second prediction-based action. The second action threshold may be less than (or greater, etc.) the first action threshold, such that a second prediction-based action may be performed in the event that a validation prediction and/or the like achieves a second action threshold but not the first action threshold. In some examples, the hierarchical threshold scheme may define at least one of a clearance threshold, a reimaging threshold, an image review threshold, a manual inspection threshold, and/or the like, each corresponding to a respective prediction-based action.

In some embodiments, the term “prediction-based action” refers to an action that may be performed for a production line item based on a prediction, such as the validation predictions described herein. In some examples, a prediction-based action may include a plurality of line routing actions that each correspond to a different action threshold.

In some embodiments, the term “action threshold” refers to a validation prediction threshold that corresponds to a particular production line routing action. An action threshold, for example, may include a numerical range, a numerical value, and/or the like that describes a criterion for evaluating a validation. An action threshold, for example, may include minimum value (e.g., percentage, etc.) for performing a particular production line routing action.

In some embodiments, the term “production line routing action” refers to a prediction-based action that is performed by one or more control components of a production line. A production line routing action, for example, may include one or more control operations for controlling a motor (and/or other control mechanism) of a conveyance assembly to initiate a movement of a production line item from an origin location to a destination location. A production line routing action may include a movement of a conveyor belt to move a production line item in a forward direction. In addition, or alternatively, a production line routing action may include a movement of one or more diverting assemblies to reroute a production line item on a conveyance assembly.

In some embodiments, the term “clearance action” refers to a production line routing action that moves a production line item in a forward direction without rerouting the production line item for further inspection. A clearance action, for example, may include a pass routing action allowing the production line item to proceed. In some examples, a clearance action may correspond to a clearance threshold. In some examples, a clearance threshold may be a highest (or lowest) threshold in a hierarchical threshold scheme.

In some embodiments, the term “reimage action” refers to a production line routing action that diverts a production line item for further inspection. A reimage action, for example, may include diverting a production line item to another camera system for performing one or more imaging operations, as described herein, to generate one or more second validation predictions. In some examples, a reimaging action may further include routing a production line item to a shuffling machine to reshuffle one or more contents within the production line item. In some examples, a reimage action may correspond to a reimage threshold. In some examples, a reimage threshold may be a lower (or higher) threshold relative to a clearance threshold, but higher than one or more other thresholds (e.g., an image review threshold, etc.) in a hierarchical threshold scheme.

In some embodiments, the term “image review action” refers to a production line routing action that diverts a production line item for further inspection. A manual inspection action, for example, may include a minor routing action which allows the production line item to be verified based on the production line image. For example, a process control action may be triggering an exception that causes a user interface depicting the production line image as well as the physical production attributes of the production line image to be presented to the human inspector. In some examples, an image review action may correspond to an image review threshold. In some examples, an image review threshold may be a lower (or higher) threshold relative to a reimage threshold, but higher than one or more other thresholds (e.g., a manual inspection threshold, etc.) in a hierarchical threshold scheme.

In some embodiments, the term “manual inspection action” refers to a production line routing action that diverts a production line item for further inspection. A manual inspection action, for example, may include a major routing action which requires a manual verification of the contents in a production line item. A manual inspection action may include triggering an exception that causes a production line item associated with a production line image to be diverted to a human inspector. A manual inspection action may be triggering an exception that causes a production line item associated with a production line image to be diverted to a human inspector and a user interface depicting the production line image to be presented to the human inspector. In some examples, a manual inspection action may correspond to a manual inspection threshold. In some examples, a manual inspection threshold may be a lowest (or highest) in a hierarchical threshold scheme.

In some embodiments, the term “transformed image” may refer to a data entity that describes a production line image augmented by one or more image transformation operations. For instance, a transformed image may include a cropped image from a production line image. The cropped image may include a portion of the production line image that is reflective of a target object within the production line item. By way of example, in a pharmaceutical production line, a production line image may be reflective of an open pill bottle within a puck. The open pill bottle may include a plurality of unidentified objects (e.g., pill capsules, etc.) and the transformed image may include a portion of the production line image that reflects an area within the open pill bottle.

In some embodiments, the term “image transformation operation” refers to a set of operations for generating a transformed image from a production line image. An image transportation operation may include one or more image cropping operations, color enhancement operations, noise reduction operations, lightness correction operations, and/or the like.

By way of example, an image transformation operation may include one or more image cropping operations, such as: (i) a set of size-based crop operations that are configured to crop a production line image to a specific size (e.g., 224×224 pixels) starting at a predefined location (e.g., the top-left corner of the image) to generate a cropped image; (ii) a set of center crop operations to crop the production line image to a specific size (e.g., 224×224 pixels) relative to a center point of the image while maintaining an original aspect ratio to generate a cropped image.; (iii) a set of vial removal crop operations on the production line image to generate a cropped image; and/or (iv) a set of sliding window intelligent crop operations (e.g., by using a sliding window object detection algorithm starting with a window size of 224×224 and a step size of five to detect and count the number of Binary Robust Invariant Scalable Keypoints (BRISKs) found in each of the sliding windows and selecting the sliding window containing the maximum number of BRISKs) on the production line image to generate a cropped image.

In addition, or alternatively, the image transformation operation may include one or more color enhancement operations, such as a color channel selection scheme in which one or more different color channel schemes may be leveraged based on a validation category associated with a production line image. In some examples, a color channel scheme may include adjusting a global contrast across image pixels of the cropped image to generate a transformed image (e.g., in order to help better distribute frequent intensity values and enhance over- or under-exposed sections of the fourth image). In some examples, an image transformation operation may include a mask operation that includes masking all pixels of an image to zero and replacing each pixel with the calculated mean of pixels in any given color channel across the image. The image transformation operations further include, if the selected color channel scheme is the LAB color channel scheme, transferring the L channel (representing lightness) of a specimen image (e.g., a specimen image selected by a human expert) for the target validation category associated with the production line image to the image to generate the transformed image.

In some embodiments, the term “extracted image-based feature” may refer to a data entity that is configured to describe an extracted feature of a production line image that is extracted from the image data of the production line image and/or derivative transformed images associated therewith. Examples of extracted image-based features include key point descriptors for the production line image, such as key point descriptors generated by decomposing the production line image to key points that represent a unique feature (e.g., using BRISK feature detection techniques that decompose the production line image (and/or derivative transformed images associated therewith) to key points that represent a unique feature defined in a 128-vector descriptor). Some techniques for generating key point descriptors for production line images are described in Zheng et al., An Algorithm for Accuracy Enhancement of License Plate Recognition, Journal of Computer and System Sciences (2013), available online at https://www.sciencedirect.com/science/article/pii/S0022000012001018.

In some embodiments, the term “item attribute” refers to a data construct that describes data related to a production line item and/or one or more objects contained within a production line item. In some embodiments, an item attribute describes shape-specific, curvature-specific, and/or object-specific data related to a production line item and/or one or more objects contained within a production line item.

In some embodiments, the term “physical production attribute” refers to a data entity that is configured to describe a property associated with production of the production line associated with a production line image. Examples of physical production attributes include a site identifier associated with a pharmacy site of a production line item, a fill line number associated with a fill line of a production line item, a camera identifier for a camera device used to capture a production line image of a production line item, attributes describing one or more camera/flash settings for a camera device used to capture a production line image of a production line item, attributes describing date and/or time of capture of a production line image of a production line item, and/or the like.

In some embodiments, the term “cropped image” refers to a data entity that describes a cropped version of a production line image. In some embodiments, a cropped image is generated via an image cropping process. In some embodiments, the image cropping process may utilize an edge detection model to detect an opening of a production line image portrayed in the production line image. Additionally, the image cropping process may generate the cropped image based on information provided by the edge detection model. In some embodiments, the cropped image may be generated from a production line image based on an outer circumference associated with a production line item.

In some embodiments, the term “derivative cropped image” refers to a data entity that describes a cropped version of a cropped image. In some embodiments, a derivative cropped image is generated via an image cropping process that is different than an image cropping process associated with generation of the cropped image. In some embodiments, the image cropping process that generates the derivative cropped image may utilize one or more item attributes associated with a production line item to generate the derivative cropped image. For example, the image cropping process that generates the derivative cropped image may utilize one or more item attributes associated with a production line item to further crop the cropped image. In some embodiments, the derivative cropped image may be generated from the cropped image based on an interior circumference associated with the production line item.

In some embodiments, the term “transformed input image” refers to a data entity that describes a transformed version of a derivative cropped image. In some embodiments, a transformed input image is generated via an input formatting process that applies one or more geometric transfer function to the derivative cropped image to generate the transformed input image. In some embodiments, the input formatting process utilizes one or more model parameters of a machine learning detection model to configure the geometric transfer function applied to the derivative cropped image to generate the transformed input image.

### IV. OVERVIEW AND TECHNICAL IMPROVEMENTS

Various embodiments of the present disclosure provide image processing techniques that improve traditional image-based prediction techniques, such as those used in the performance of production line conformance monitoring. To do so, embodiments of the present disclosure provide methods, apparatus, systems, computing devices, computing entities, and/or the like for production line conformance monitoring that leverage preprocessing of a production line image for a machine learning detection model to provide an improved prediction output related to a target validation category. Some embodiments of the present disclosure improve the accuracy, reliability, and coverage of such machine learning detection models using various transformations related to a production line image via image processing techniques. For example, some techniques of the present disclosure may utilize one or more image cropping stages and/or one or more image transformation stages for a production line image to generate a transformed input image for a machine learning detection model in order to improve the performance of the. By doing so, the machine learning detection model may maintain or surpass an acceptable level of performance for providing prediction output related to a target validation category. In this manner, the performance of the machine learning models may be maintained for various environmental conditions and/or various type of captured imagery quality related to a production line by intelligently optimizing an input image for machine learning.

Various embodiments of the present disclosure provide techniques for efficiently and reliably performing conformance monitoring of a production line in order to determine defective/non-conformant production line items. For example, by enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. Additionally, by enabling the noted functionalities and associated advantages, various embodiments of the present disclosure reduce the operational load on production line control systems and thus improve the operational efficiency and the operational reliability of the noted production line control systems.

An exemplary application of various embodiments of the present disclosure relates to validating and confirming whether pills contained in a vial are the correct pills identified by a pill identifier. For example, various embodiments of the present disclosure train and implement a machine learning detection model (e.g., a binary classification convolutional neural network model) to generate a signal indicating whether a ground truth identity of the pills matches a predicted identity based on a provided pill identifier. A key benefit of various embodiments of the present disclosure is to ensure and validate that incorrect medication is not administered and distributed. Various health risks arise when an incorrect medication is consumed; thus, various embodiments of the present disclosure may serve as a vital tool to prevent or reduce occurrence of such health risks. Various embodiments of the present disclosure may also be applied to detecting foreign bodies inadvertently contained or packaged with pills in a vial.

Various embodiments of the present disclosure are configured to collect and process production line images in order to distinguish pills of a target NDC from other pills. A production line image captured at a production line may be processed via one or more image cropping stages and/or one or more image transformation stages before being provided to the machine learning detection models for generating a prediction output related to the production line image. In some embodiments, the prediction output may be based on an identification of a cohort of similar NDCs to a target NDC for which the production line image and/or information contained therein is relevant. In various embodiments, a prediction output provided by a machine learning detection model may identify a pill associated with a defined NDC. For example, a machine learning detection model may be to distinguish pills of a target NDC from other pills with respect to one or more production line images based on a cohort of similar NDCs to the target NDC.

In various embodiments, a production line image may be processed using one or more image transformations before being provided as input to a machine learning detection object. In various embodiments, the one or more image transformations may include cropping of a production line image based on an outer defined shape (e.g., an outer circumference) and/or an interior defined shape (e.g., an interior defined shape) associated with a pill vial that includes pills. In various embodiments, a production line image may be cropped to a specific size, cropped from the center of the production line image, cropped to remove the vial containing the pills from the production line image (e.g., by using a deep learning model to locate the pill vial in the production line image), and/or cropped to a window containing a maximum number of key or important features (e.g., using Sliding Window Intelligent Crop and cropping to a window containing a maximum number of Binary Robust Invariant Scalable Keypoints (BRISK)). In various embodiments, a production line image may be additionally or alternatively cropped based on a curvature of a bottom portion of a pill vial, a number of pills contained in a pill vial, a type of pills contained in a pill vial, visual characteristics (e.g., color and/or shape) of the pills contained in the pill vial, and/or visual characteristics (e.g., color and/or shape) of the pill vial.

Additionally or alternatively, various image transformations may be performed on a production line image based on a combination of the target NDC and other data such as Physical Fill Attributes (PFAs). For example, Physical Fill Attributes may include pharmacy site location, fill line number, camera identifier, camera and flash settings, data, and/or time. As another transformation, a production line image may be enhanced and/or normalized. Various enhancing and normalizing operations may be based on a selected color space for each image. Lightness correction may be performed for images in the LAB color space. Lightness correction involves transferring the L channel (representing lightness) from a specimen image representing a particular NDC to images in a training set of the same particular NDC. In various embodiments, histogram equalization may be performed for images in the RGB color space. Histogram equalization adjusts global contrast across image pixels to better distribute frequent intensity values, thereby enhancing over or under exposed portions of the image. Specifically, histogram equalization may calculate a cumulative distribution function for pixel values of an image, masking all pixel values to 0, and replacing the pixel values with a calculated mean pixel value for each channel (e.g., R channel, G channel, B channel in RGB color space). BRISK feature detection may be performed to identify dense areas of key points in an image (typically representative of an imprint on the surface of a pill), which can then be used to feature match between different images for image alignment. Thus, for example, different image transformations may be performed to optimize an input image provided to a machine learning detection model.

Some embodiments describe a system including trained machine learning detection models and/or the datastore containing the trained machine learning detection models and other data that may receive an image of pills in a vial and be tasked with determining whether the pills are pills identified by a specific NDC. In such examples, the system may implement a software Application Programming Interface (API) and receive an API call, which may include an input image (e.g., a production line image) of pills in a vial, a NDC representing the suspected identity of the pills in the input image, and other data such as PFAs, and subsequently generate and return an API response with an indication or signal whether the pills identified in the input image are correctly identified by received NDC. In various embodiments, the input image may undergo one or more image transformation as further disclosed herein to improve quality of input data provided to a trained machine learning detection model. In certain embodiments, a row in the datastore may be identified that corresponds to the received NDC and/or PFAs. In some examples, if no row is identified to correspond to the received NDC and/or PFAs, the system generates an exception signal indicating that the pills identified in the input image are not correctly identified by the received NDC. Otherwise, the input image may be measured for blurriness and brightness and may also be transformed according to the model-specific transformations indicated by the row in the datastore. The transformed input image is then passed to the one or more CNN models indicated by the row in the datastore. Image measurements and the model results are compared to threshold values indicated by the row in the datastore using rules indicated by the row in the datastore. Based on the evaluation of the rules, an output signal may be generated and provided. The output signal may be configured to indicate whether the pills in the input image match the received NDC. Specifically, the output signal may comprise values representing “Exception,” “Not Exception,” or “Error.” Based on the output signal, various actions may be performed. For example, an “Exception” output signal may cause the vial identified by the input image to be redirected to a human pharmacist or technician for manual validation. As another example, an “Exception” output signal may cause the vial identified by the input image to be refilled with new pills, and the system may reevaluate based on another input image taken of the vial with new pills. In some examples, a separate output signal may be provided to indicate that a foreign object is detected in the input image. In some examples, the input image may be used to retrain or further train one or more CNN models.

In certain embodiments of the present disclosure, production line conformance measurement techniques using optimized preprocessing of an input image for a machine learning detection model are provided to improve performance of a machine learning detection model and/or to account for quality disparities for images captured at a production line site. The intelligent preprocessing of an input image for image-based pill detection related to a pill vial with a plurality of pills may include generating a cropped image from an input image reflective of a pill vial with a plurality of pills, generating a derivative cropped image from the cropped image by removing a center portion of the cropped image, generating a processed model input image for a machine learning detection model based on the derivative cropped image, and/or generating, using the machine learning detection model, a prediction based on the processed model input image. The cropped image may be cropped around the pill vial opening to remove the exterior portion of image that is not within an outline of the pill vial. Additionally, the resulting cropped image may be a defined shape related to the pill vial opening such as a circle. For the derivative cropped image, the size of the center portion may be based on (i) a curvature of a bottom portion of a pill vial, (ii) a number/type of pills within the pill vial, and/or (iii) a color of the pills and/or pill vial. In certain embodiments, the processed model input image may be generated by applying a geometric transformation function to the derivative cropped image to generate a rectangular version of the derivative cropped image. Additionally, the rectangular version of the derivative cropped image may be scaled to a model size that is expected by the machine learning detection model. In various embodiments, the machine learning detection model may include a convolutional neural network that expects a sliding window input. As such, the improved image-based pill detection techniques may be provided to improve upon technical challenges related to traditional image-based pill detection techniques such as, for example, scenarios with lower fill levels of pills in pill vials in which a bottom portion of a pill vial may cause a model to misclassify the contents within the pill vial.

The above-described process may improve traditional machine learning models with respect to adaptability in changing environments and/or captured imagery for a production line. The effectiveness of the traditional machine learning models is limited to the raw imagery provided to the models, which may involve image quality issues as the characteristics of a prediction domain change (e.g., due to camera defects, seasonality changes, camera lighting, camera noise, timing of imagery capture with respect to production line items, etc.). To account for these and/or other inefficiencies related to traditional machine learning models, the data preprocessing techniques of the present disclosure for machine learning enable improved performance of machine learning models based on real time image processing for input images provided to machine learning models. The input images, for example, may include optimized production line images that are processed while the machine learning model is being used in production. In the way, model input data for a machine learning model may be continuously improved using data that accounts for changes within an environment and/or for captured imagery, thereby adapting the machine learning model over time to overcome deficiencies traditionally caused by prediction domain change.

Examples of technologically advantageous embodiments of the present disclosure include: (i) improved machine learning detection models for generating predictions tailored to various production line items within a distribution facility, (ii) data preprocessing techniques for optimizing input images provided to machine learning detection models, (iii) continuous model monitoring and inference techniques for a production line, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to image-based prediction techniques. In particular, systems and methods are disclosed herein that implement image and prediction processing techniques to improve machine learning model performance with respect to image predictions. By doing so, improved predictions may be generated, using machine learning models, that directly address traditional model deficiencies, such as false negatives or false positives due to noisy and/or low quality imagery provided to a machine learning model. As described herein, these predictions may be leveraged to improve various prediction-based action, which may result in improved automation techniques within distribution facilities.

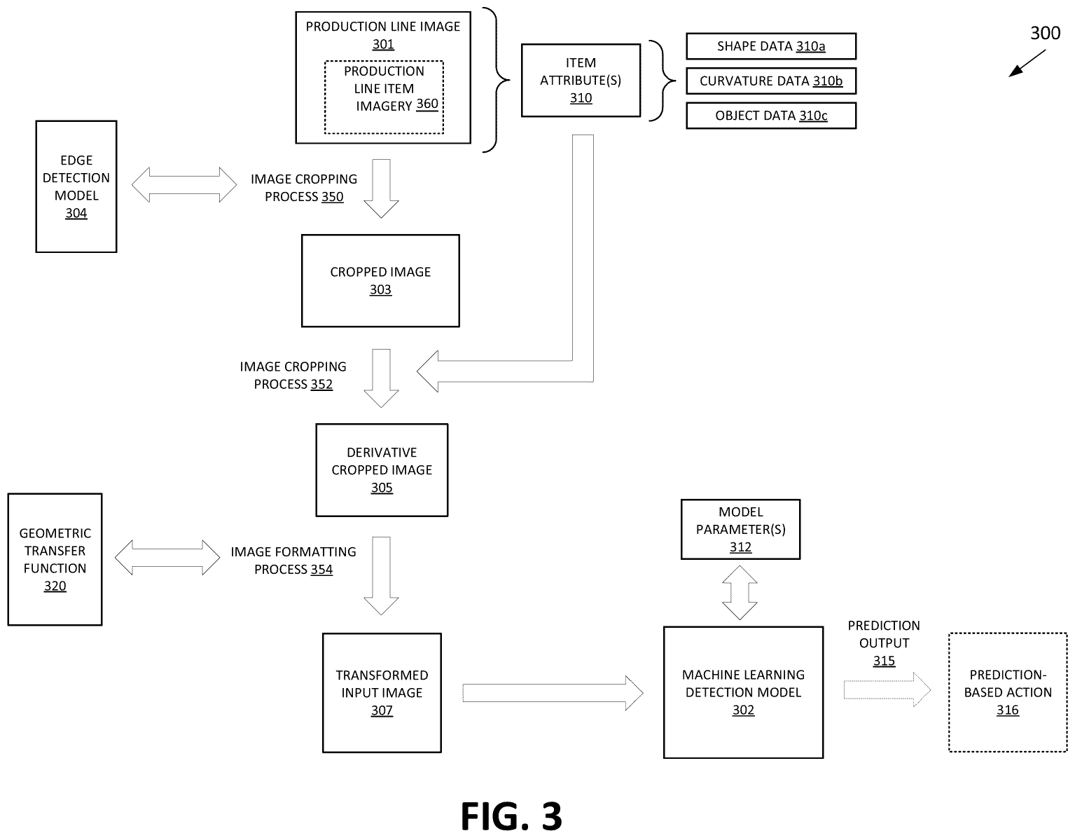

FIG. 3 is a dataflow diagram 300 showing example data structures and modules for generating predictions from production line images in accordance with some embodiments discussed herein. The dataflow diagram 300, for example, illustrates intelligent image preprocessing for a machine learning detection model 302. The machine learning detection model 302 may be configured to generate a validation prediction related to a production line image 301. The image preprocessing for the machine learning detection model 302 may be leveraged to improve machine learning predictions to account for environmental changes and/or captured production line images, such as camera occlusions, noisy imagery, low quality imagery, and/or the like related to a production line.

In some embodiments, the production line image 301 is reflective of a production line item associated with a target validation category. In some embodiments, the target validation category is one of a plurality of validation categories associated with a production line. The machine learning detection model 302 may be associated with a categorical validation ensemble model including a plurality of machine learning detection models respectively corresponding to the plurality of validation categories. The machine learning detection model 302 may include a model from the categorical validation ensemble model that corresponds to the target validation category.

In some embodiments, the categorical validation ensemble model is a plurality of machine learning detection models. A categorical validation ensemble model, for example, may include a separate machine learning detection model for each validation category associated with a production line. In some examples, for a pharmaceutical production line, a categorical validation ensemble model may include a separate machine learning detection model for each NDC of a plurality of NDC processed by the pharmaceutical production line.

In some embodiments, a validation category is a data entity that describes a category defined by a subset of image attributes, where validation predictions are generated with respect to the validation category. For example, a validation prediction may be generated with respect to a particular drug type identifier (e.g., NDC), where the validation prediction may describe whether corresponding production line images depict objects (e.g., pill capsules, etc.) associated with the drug type identifier. As another example, validation predictions may be generated with respect to a particular drug type identifier and a particular site identifier, where the validation predictions may describe whether corresponding production line images depict objects associated with the drug type identifier that are generated at the particular site identifier. As yet another example, validation predictions may be generated with respect to a particular drug type identifier, a particular site identifier, and/or a particular fill line number, where the validation predictions may describe whether corresponding production line images depict objects associated with the drug type identifier that are generated at the particular fill line number of the particular site identifier. In general, any combination of one or more defined image attributes may be used to characterize a validation category.

In some embodiments, the production line image 301 may be a data entity that describes an image captured at a location on a production line. For example, the production line image 301 may be captured by a camera located relative to (e.g., above, etc.) the location and configured to capture an image of a production line item on a production line as the production line item passes the location. An example of a production line item on a production line is a to-be-filled prescription progressing along steps of a production line in a radio frequency (RF)-controlled container called a puck, where inside the puck may be a pill bottle, and where a pharmacy production line software may, via the RF signals, control the progress of each puck to process the pill bottle in accordance with a prescription. In some examples, if the production control equipment and software detect an error with the production line item (e.g., the pill bottle is significantly underweight, meaning it was not filled completely, etc.), the software may generate an exception and physically route the puck to a human for further inspection and/or resolution. In today's commercial pharmacy world, overhead images may be taken of each pill bottle and stored before they are capped and shipped. In some embodiments, the production line image 301 may include an overhead image that depicts an overhead view of pill bottle before the pill bottle is capped and dispatched for delivery to an end user, such as a pharmacy, individual, and/or the like.

In some embodiments, the production line image 301 is captured by a plurality of different cameras positioned at various different locations of a production line. In some examples, the production line image 301 may be processed, using some of the techniques of the present disclosure, to detect an error associated with a production line item. In some examples, at least a portion of the production line image 301 may be assigned a ground-truth label by the machine learning detection model 302. As described herein, the ground-truth label for the production line image 301 may identify a validation category and/or a validation result for the production line image 301.

In some embodiments, the machine learning detection model 302 is a data entity that is configured to describe parameters, hyper-parameters, and/or defined operations of a machine learning model that is configured to determine whether an input production line image (e.g., the production line image 301) corresponds to a target validation category that is associated with the machine learning detection model. In some embodiments, the machine learning detection model 302 is configured to process at least one of (i) an input image (e.g., as a matrix), such as a production line image and/or the like, (ii) extracted image-based features values associated with the input image (e.g., as a vector), and/or (iii) one or more physical production attributes for the input image (e.g., as a vector), in order to determine a validation prediction for the production line image 301 that describes whether the production line image 301 corresponds to a target validation category that is associated with the machine learning detection model 302.

In some embodiments, the machine learning detection model 302 includes a convolutional neural network, such as a binary classification convolutional neural network, that is characterized by at least one of (i) five layers including four two-dimensional convolutional layers and one flattening layer, (ii) filters that are increased across the two-dimensional convolutional layers to capture patterns and details in the input image, and/or (iii) each 2-dimensional convolutional layer utilizes a rectified linear unit (ReLU) activation function. In some embodiments, each two-dimensional convolution operation in a two-dimensional convolutional layer is followed by a pooling operation (e.g., with a size and stride of two), where dropout values are increased across two dimensional convolutional layers to a maximum value (e.g., a maximum value of 0.7). In some embodiments, the machine learning detection model 302 is trained using a binary cross-entropy loss function, with constant label smoothing (e.g., constant label smoothing at 0.1 to train the model with mislabeled data and with improved overall robustness and accuracy). In some embodiments, to train the machine learning detection model 302, an optimization function such as Adam Optimizer function or a Stochastic gradient descent optimizer function is utilized. While various embodiments of the present disclosure describe that the machine learning detection model 302 includes a convolutional neural network, a person of ordinary skill in the relevant technology will recognize that any machine learning model (e.g., any neural network, such as any pre-trained neural network) may be utilized as part of the machine learning detection model 302.

In some embodiments, the computing system 100 may perform an image cropping process 350 to generate a cropped image 303 from the production line image 301 based on an outer defined shape associated with a production line item portrayed in the production line image 301. For example, the computing system 100 may generate the cropped image 303 based on an outer circumference associated with a production line item. In some embodiments where the production line item is a vial container (e.g., a pill vial), the computing system 100 may generate the cropped image 303 based on an outer edge of the vial container. In some embodiments, the computing system 100 may utilize an edge detection model 304 to detect the outer defined shape (e.g., the outer circumference) associated with a production line item. The edge detection model 304 may utilize one or more edge detection techniques to detect the outer defined shape (e.g., the outer circumference) associated with a production line item. In some embodiments where the production line item is a vial container (e.g., a pill vial), the edge detection model 304 may utilize one or more edge detection techniques to detect an outer edge of an opening of the vial container.

In some embodiments, the computing system 100 may perform an image cropping process 352 to generate a derivative cropped image 305 from the cropped image 303 based on an interior defined shape associated with the production line item. For example, the computing system 100 may generate the derivative cropped image 305 based on an interior circumference associated with the production line item. In some embodiments where the production line item is a vial container (e.g., a pill vial), the computing system 100 may generate the derivative cropped image 305 based on an interior edge of an opening of the vial container.

In some embodiments, the computing system 100 may generate the derivative cropped image 305 based on one or more item attributes 310 related to a production line item associated with the production line image 301. For example, the production line image 301 may include production line item imagery 360 that portrays the production line item. The one or more item attributes 310 may include shape data 310a, curvature data 310b, and/or object data 310c related to the production line item. The shape data 310a may include one or more shape attributes associated with the production line item such as, but not limited to, a defined shape (e.g., circle, square, rectangle, etc.) associated with an opening of the production line item, a size of the opening of the production line item, and/or a circumference (e.g., an interior circumference) of the opening of the production line item. The curvature data 310b may include one or more curvature attributes associated with the production line item such as, but not limited to, a curvature of a bottom portion of the production line item, a defined shape (e.g., circle, square, rectangle, etc.) associated with the bottom portion of the production line item, a size of the bottom portion of the production line item, an area of the bottom portion of the production line item, and/or a circumference of the bottom portion of the production line item. The object data 310c may include one or more object item attributes associated with one or more objects contained within the production line item such as, but not limited to, one or more visual characteristics (e.g., color, shape, and/or size) of the production line item, one or more visual characteristics (e.g., color, shape, and/or size) of the object within the production line item, a type of objects within the production line item, and/or a number of objects within the production line item. In some embodiments, a type of object may be determined based on a drug type identifier (e.g., NDC identifier, etc.) associated with an object.

In some embodiments, the computing system 100 may perform an image formatting process 354 to generate a transformed input image 307 from the derivative cropped image 305. In some embodiments, the computing system 100 may generate the transformed input image 307 from the derivative cropped image 305 based on one or more model parameters 312 of the machine learning detection model 302. The one or more model parameters 312 may include one or more parameters of the machine learning detection model 302 to facilitate properly formatted model input data for the machine learning detection model 302. For example, the one or more model parameters 312 may indicate a size, shape, position, and/or orientation of pixels to satisfy model input data requirements for the machine learning detection model 302. In some embodiments, the one or more model parameters 312 may include one or more parameters of the machine learning detection model 302 to facilitate scaling of the derivative cropped image 305 into the transformed input image 307 that satisfies mode input rules for the machine learning detection model 302. In some embodiments, the one or more model parameters 312 may include a model input size associated with the machine learning detection model 302. The model input size may be defined by a set of sliding window parameters for model input data of the machine learning detection model 302.

In some embodiments, the computing system 100 may apply a geometric transformation function 320 to generate the transformed input image 307. In some embodiments, the computing system 100 may apply the geometric transformation function 320 based on the one or more model parameters 312. In some embodiments, the computing system 100 may apply the geometric transformation function 320 to the derivative cropped image 305 to generate a rectangular version of the derivative cropped image 305. Additionally, the rectangular version of the derivative cropped image 305 may be scaled to a model size that is expected by the machine learning detection model 302. As such, the transformed input image 307 may correspond to the scaled rectangular version of the derivative cropped image 305. In some embodiments, the geometric transformation function 320 may modify and/or spatially arrange pixels of the derivative cropped image 305 to satisfy the one or more parameters of the machine learning detection model 302. In some embodiments, the geometric transformation function 320 may include scaling, rotating, translating, shifting, and/or shearing of one or more pixels of the derivative cropped image 305 to generate the transformed input image 307.

In some embodiments, the computing system 100 may provide the transformed input image 307 as input to the machine learning detection model 302. In some embodiments, the computing system 100 may apply the machine learning detection model 302 to the transformed input image 307 to generate a prediction output 315. The prediction output 315 may include a prediction, inference, classification, and/or label associated with the production line image 301. In some embodiments, the prediction output 315 may be a validation prediction related to the production line image 301. Additionally, in some embodiments, the computing system 100 may initiate the performance of one or more prediction-based actions 316 based on the prediction output 315. In some embodiments, the prediction-based action 316 is a machine learning action. In some embodiments, the performance of a prediction-based action 316 may be initiated based on the prediction output 315.

In some embodiments, the prediction-based action 316 is an action that may be performed for a production line item based on the prediction output 315, such as a validation prediction described herein. In some embodiments, the prediction output 315 includes a data entity that is configured to describe a conclusion about whether the production line image 301 is associated with a corresponding validation category. For example, the prediction output 315 may describe (i) an affirmative likelihood that a corresponding production line image describes an object (e.g., pill capsule, etc.) for a validation category and/or (ii) a negative likelihood that a corresponding production line image does not describe an object for a validation category, and/or the like. By way of example, the prediction output 315 may include a prediction score indicative of an affirmative and/or negative category likelihood. The prediction score may include a binary number (e.g., 0 or 1), a numerical range, a ratio, a percentage, and/or the like. In some examples, the prediction score may include a number between zero and one.

In some embodiments, the prediction output 315 describes at least one of an affirmative category likelihood for the production line image and/or a negative category likelihood for the production line image. In some embodiments, the prediction output 315 describes at least one of a smoothed affirmative likelihood for the production line image and/or a smoothed negative category likelihood for the production line image. An affirmative category likelihood may describe a value generated by the machine learning detection model 302 that describes a likelihood that the production line image 301 corresponds to a validation category associated with the machine learning detection model 302. A negative category likelihood may describe a value generated by the machine learning detection model 302 that describes a likelihood that the production line image 301 does not correspond to a validation category associated with the machine learning detection model 302. In some embodiments, the affirmative category likelihood and/or the negative category likelihood are processed using a likelihood smoothing transformation to determine a smoothed affirmative likelihood and/or a smoothed negative category likelihood.

In some embodiments, the prediction-based action 316 includes one of one or more production line routing actions associated with a production line of the production line site. For example, the one or more production line routing actions may include (a) a clearance action associated with a clearance threshold, (b) a reimage action associated with a reimage threshold, (c) an image review action associated with a review threshold, and/or (d) a manual inspection action associated with an inspection threshold. In some examples, the clearance threshold, the reimage threshold, the review threshold, and/or the inspection threshold may define a hierarchical threshold scheme.

In some examples, the prediction-based action 316 may be identified from the one or more production line routing actions based on a comparison between a validation prediction and one or more action thresholds. In some embodiments, an action threshold is a validation prediction threshold that corresponds to a particular production line routing action. An action threshold, for example, may include a numerical range, a numerical value, and/or the like that describes a criterion for evaluating a validation prediction. An action threshold, for example, may include minimum value (e.g., percentage, etc.) for performing a particular production line routing action. In some embodiments, the process control database is a set of one or more data entities (e.g., a set of data entities stored in a distributed manner) that contain data for a database that describes, for each validation category of a set of defined validation categories, an action threshold for the validation category and one or more process control parameters for the validation category, where the action threshold for the validation category may describe a condition that, when satisfied by the validation prediction for a production line image with respect to the validation category, causes performance of one or more production line control actions based on one or more process control parameters associated with the validation category.

In some embodiments, the action threshold may recommend that, when a validation prediction for a production line image with respect to a corresponding validation category exceeds a particular numeric value, the one or more production line control actions for the corresponding validation category should be performed. As another example, the action threshold may recommend that, when a validation prediction for a production line image with respect to a corresponding validation category falls below a particular numeric value, the one or more production line control actions for the corresponding validation category should be performed.

In some embodiments, the process control database may describe, for each validation category of a set of defined validation categories, specific image transformation requirements and measurement parameters associated with the validation category, such as properties associated with the crop, enhancement, and measurement transformations for the validation category. In some embodiments, the process control database may describe data associated with each validation category in a row of a relational database, where the row is associated with the validation category. In some embodiments, the process control database may describe data associated with each validation category in a column of a relational database, where the column is associated with the validation category.

In some embodiments, the prediction-based action 316 is a production line routing action that is performed by one or more control components of a production line. A production line routing action, for example, may include one or more control operations for controlling a motor (and/or other control mechanism) of a conveyance assembly to initiate a movement of a production line item from an origin location to a destination location. A production line routing action may include a movement of a conveyor belt to move a production line item in a forward direction. In addition, or alternatively, a production line routing action may include a movement of one or more diverting assemblies to reroute a production line item on a conveyance assembly.

In some embodiments, a clearance action is a production line routing action that moves a production line item related to the production line image 301 in a forward direction without rerouting the production line item for further inspection. A clearance action, for example, may include a pass routing action allowing the production line item to proceed. In some examples, a clearance action may correspond to a clearance threshold. In some examples, a clearance threshold may be a highest (or lowest, etc.) threshold in a hierarchical threshold scheme.

In some embodiments, a reimage action to a production line routing action that diverts a production line item related to the production line image 301 for further inspection. A reimage action, for example, may include a diverting a production line item to another camera system for performing one or more imaging operations, as described herein, to generate one or more second validation predictions. In some examples, a reimaging action may further include routing a production line item to a shuffling machine to reshuffle one or more contents within the production line item. In some examples, a reimage action may correspond to a reimage threshold. In some examples, a reimage threshold may be a lower (or higher, etc.) threshold relative to a clearance threshold, but higher (or lower, etc.) than one or more other thresholds (e.g., an image review threshold, etc.) in a hierarchical threshold scheme.

In some embodiments, an image review action is a production line routing action that diverts a production line item related to the production line image 301 for further inspection. A manual inspection action, for example, may include a minor routing action which allows the production line item to be verified based on the production line image. For example, a process control action may be triggering an exception that causes a user interface depicting the production line image as well as the physical production attributes of the production line image to be presented to the human inspector. In some examples, an image review action may correspond to an image review threshold. In some examples, an image review threshold may be a lower (or higher, etc.) threshold relative to a reimage threshold, but higher (or lower, etc.) than one or more other thresholds (e.g., a manual inspection threshold, etc.) in a hierarchical threshold scheme.

In some embodiments, a manual inspection action is a production line routing action that diverts a production line item related to the production line image 301 for further inspection. A manual inspection action, for example, may include a major routing action which requires a manual verification of the contents in a production line item. A manual inspection action may include triggering an exception that causes a production line item associated with a production line image to be diverted to a human inspector. A manual inspection action may be triggering an exception that causes a production line item associated with a production line image to be diverted to a human inspector and a user interface depicting the production line image to be presented to the human inspector. In some examples, a manual inspection action may correspond to a manual inspection threshold. In some examples, a manual inspection threshold may be a lowest (or highest) in a hierarchical threshold scheme.

In this manner, using some of the techniques of the present disclosure, one or more predictive insights, such as validation predictions, may be leveraged from production line images to intelligently route production line items across a distribution facility. Improved predictive insights may be generated to facilitate accurate prediction-based actions 316 using machine learning models, such as the machine learning detection model 302 that utilizes optimized model input data (e.g., the transformed input image 307) based on the image cropping process 350, the image cropping process 352, and/or the image formatting process 354.

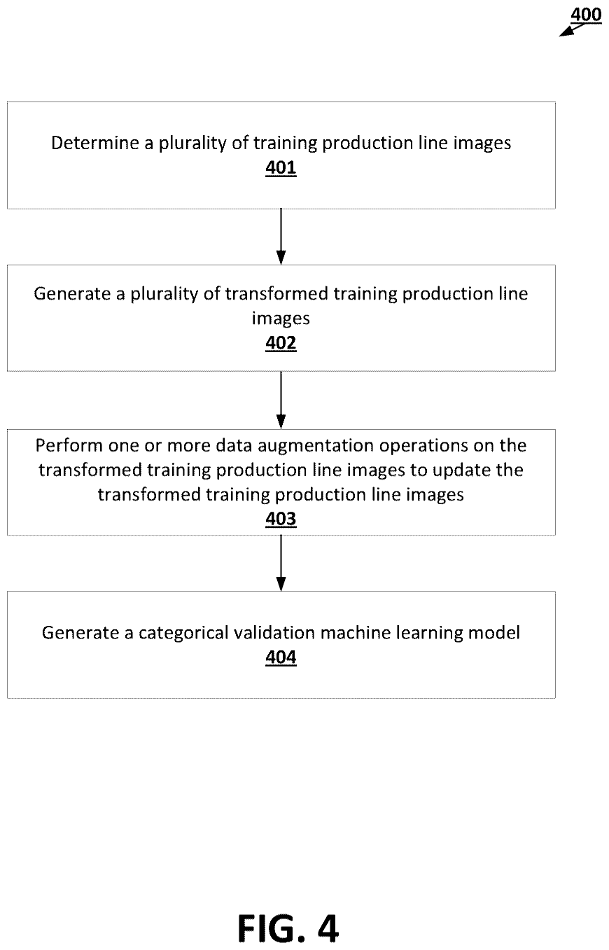

In some embodiments, the machine learning detection model 302 may be trained to further optimize performance of the machine learning detection model 302. In some embodiments, the machine learning detection model 302 may be a categorical validation machine learning model. Example training techniques for training the machine learning detection model 302 will now further be described with reference to FIGS. 4-9.

### Model Training Operations

FIG. 4 is a flowchart diagram of an example process 400 for generating a machine learning detection model (e.g., a categorical validation machine learning model) for a target validation category. The process 400 may be implemented by one or more computing devices, entities, and/or systems described herein. For example, via the various steps/operations of the process 400, the computing system 100 may leverage improved model training, configuration, and data augmentation techniques to generate categorical validation machine learning models tailored to a production line environment. By doing so, the process 400 enables improved prediction processes, using trained categorical validation machine learning models, that improve item routing within a distribution facility. In some examples, the process 400 may describe an initial training process for a machine learning detection model (e.g., a categorical validation machine learning model) such as, for example, the machine learning detection model 302. As described herein, once trained, a machine learning detection model (e.g., a categorical validation machine learning model) may be continuously retrained. In some examples, the initial training process and the retraining processes may include one or more of the same steps/operations, as described with reference to FIG. 4. In some examples, the initial training process and the retraining processes may leverage different datasets for training (and/or updating) a machine learning detection model (e.g., a categorical validation machine learning model). By way of example, a machine learning detection model (e.g., a categorical validation machine learning model) may be initially trained using a plurality of training production line images that correspond to a related category subset for a target validation category, whereas the machine learning detection model may be retrained using a plurality of training production line images that correspond to a particular target validation category and/or production line item.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence. While various embodiments of the present disclosure describe generating a categorical validation machine learning model as being performed by the same computing entity as the computing entity used to generate validation predictions by a categorical validation machine learning model, a person of ordinary skill in the relevant technology will recognize that in some embodiments a first set of one or more computing entities may generate a categorical validation machine learning model and a second set of one or more computing entities may generate the validation prediction by utilizing the categorical validation machine learning model.

The process 400 begins at step/operation 401 when the computing system 100 determines a plurality of training production line images for the target validation category. In some embodiments, the computing system 100 determines the plurality of training production line images for the target validation category based on a related category subset for the target validation category, as further described below. In some embodiments, if a production line image is associated with a ground-truth label identifying whether the production line image corresponds to a target validation category, the production line image is referred to herein as a “training production line image.”

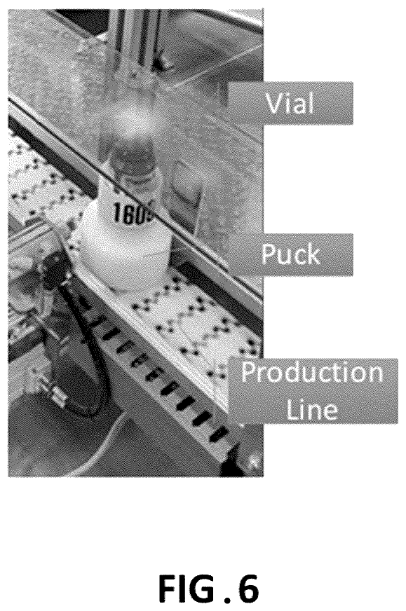

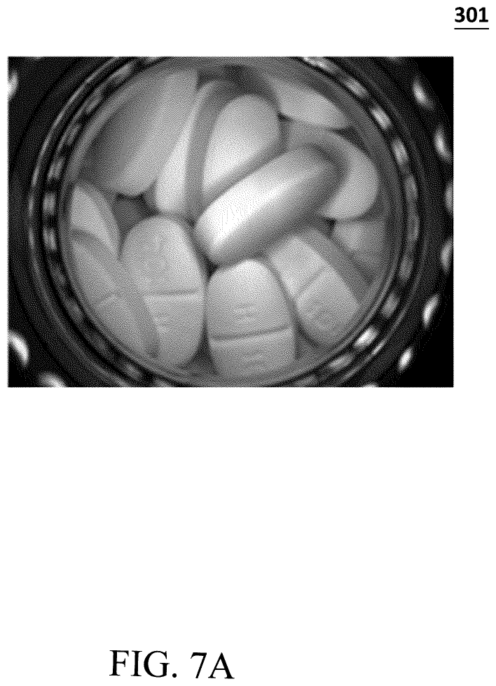

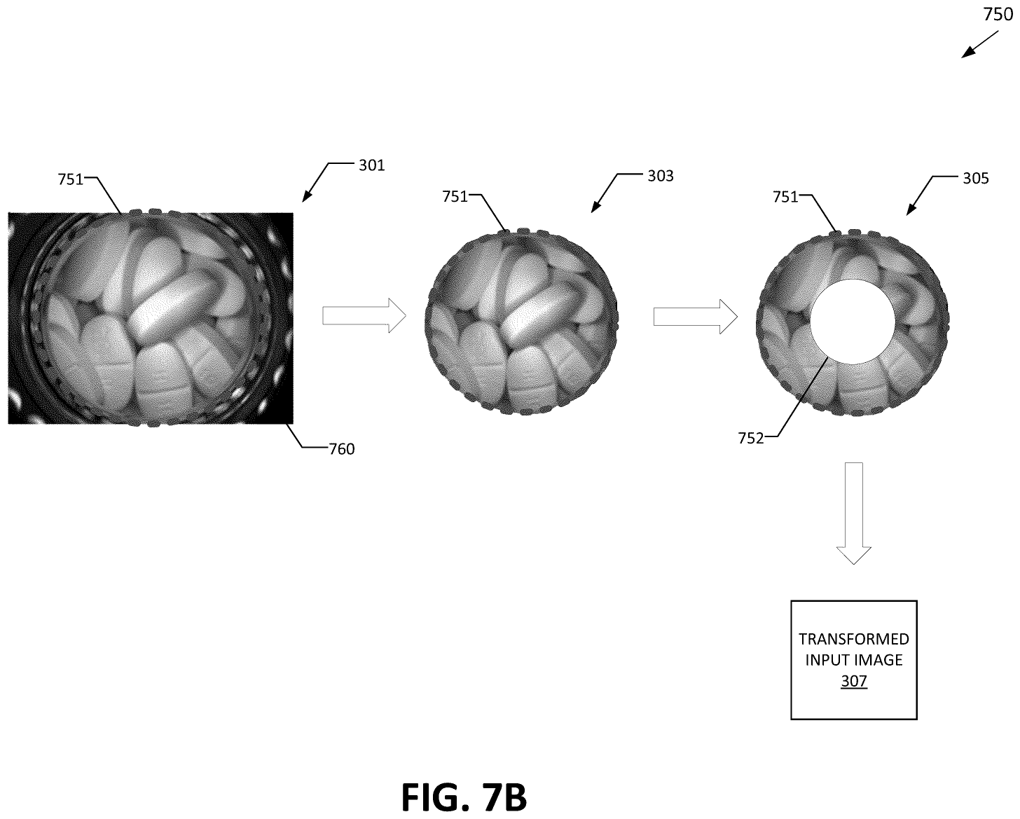

FIG. 6 provides an operational example of a radio frequency controlled container in a production line in accordance with some embodiments discussed herein. FIG. 7A provides an operational example of a production line image in accordance with some embodiments discussed herein. The production line image 301 is an overhead shot of a pill container ready to be capped and sent out. The white dashes near the outside of the photo are from external lighting. The container itself is a circular feature with amber-orange color near the outside of the image. The production line image 301 also depicts pills outside the depicted container.

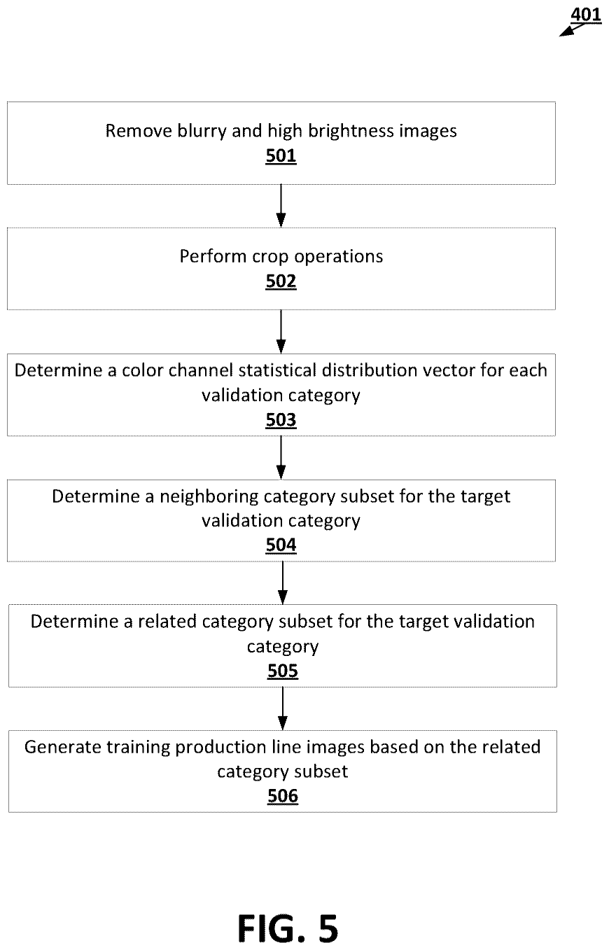

In some embodiments, step/operation 401 may be performed in accordance with the process that is depicted in FIG. 5.

FIG. 5 is a flowchart diagram of an example process for generating a plurality of training production line images in accordance with some embodiments discussed herein. The process that is depicted in FIG. 5 begins at step/operation 501 when the computing system 100 removes blurry and high brightness images from a training image dataset. In some embodiments, determining whether an image is blurry is performed by using a Laplacian of Gaussian Edge Detection algorithm (e.g., by removing images with a variance below six). In some embodiments, determining whether an image is high brightness is performed by using a root mean square (RMS) technique and by removing brightness values that are above a brightness threshold (e.g., a brightness threshold of 200). In some embodiments, removing blurry and high brightness images increases the quality of available training data and provides the opportunity to correct photography issues in production lines.

At step/operation 502, the computing system 100 performs one or more crop operations on each training production line image in the training image dataset to generate a first set of training production line images. Examples of crop operations include center crop operations (e.g., cropping a training production line image to 224×224 pixels in the center of image while maintaining the original aspect ratio), operations configured to crop the training production line image to a specific size (e.g., to a size of 224×224 starting in a predefined location like the top left corner), sliding window intelligent crop operations (e.g., by using an image pyramid and a sliding window object detection algorithm starting with a window size of 224×224 and a step size of five to detect and count the number of Binary Robust Invariant Scalable Keypoints (BRISKs) found in each of the sliding windows and selecting the sliding window containing the maximum number of BRISKs), and/or the like.

At step/operation 503, the computing system 100 determines, for each validation category, a color channel statistical distribution vector based on the one or more labeled production line images for the target validation category. In some embodiments, the computing system 100 first identifies a set of (e.g., a defined number of, such as 1000) training production line images in the first set of training production line images that are assigned a label associated with the target validation category as the set of labeled production line images for the target validation category, and subsequently determines the color channel statistical distribution vector for the target validation category based on the set of labeled production line images for the target validation category.

In some embodiments, a color channel statistical distribution vector is a data entity that is configured to describe, for each color channel of a set of color channels, a measure of statistical distribution (e.g., an average or other centroid measure) of color values associated with the color channel in pixels of a set of labeled production line images for a corresponding validation category. For example, given a validation category that is associated with a particular NDC identifier, and further given a Red-Green-Blue (RGB) color channel scheme, the color channel statistical distribution vector may describe: (i) an average pixel value for the red channel across labeled production line images that are assigned the particular NDC identifier, (ii) an average pixel value for the green channel across labeled production line images that are assigned the particular NDC identifier, and (iii) an average pixel value for the blue channel across labeled production line images that are assigned the particular NDC identifier. While various embodiments of the present disclosure describe using the color channels of the RGB color channel scheme, a person of ordinary skill in the relevant technology will recognize that other color channel schemes (e.g., Blue-Green-Red (BGR), Hue-Saturation-Lightness (HSL), Hue-Saturation-Value (HSV), the CIELAB color space (LAB), Red-Green-Blue-Alpha (RGBA), and/or the like) may be utilized. In some embodiments, the color channel statistical distribution vector for a validation category may describe statistical distribution measures of labeled production line images for the validation category across color channels defined by two or more color channel schemes.

At step/operation 504, the computing system 100 determines a neighboring category subset of a plurality of defined validation categories for the target validation category based on each color channel statistical distribution vector for a defined validation category. In some embodiments, a neighboring category subset is a data entity that is configured to describe a subset of a set of defined validation categories that are deemed similar to a target validation category based on comparing color channel statistical distribution vectors for the defined validation categories (where the set of defined validation categories includes the target validation category). For example, a neighboring category subset for a target validation category may describe an n-sized subset of a set of defined validation categories whose color channel statistical distribution vectors have the highest measures of similarity to the color channel statistical distribution vector of the target validation category (where n may for example be 20). In some embodiments, the measures of similarities of pairs of color channel statistical distribution vectors are determined using k-dimensional tree algorithms.

At step/operation 505, the computing system 100 determines a related category subset of the neighboring category subset. In some embodiments, each defined validation category of the neighboring category subset is also in the related category subset if a shape descriptor data object of the defined validation category matches the shape descriptor object of the target validation category.

In some embodiments, a related category subset is a data entity that is configured to describe a subset of the neighboring category subset for a target validation category, where the subset includes defined validation categories whose production line items are associated with respective shape feature descriptions that are determined to match a shape feature description of a production line item of the target validation category. In some embodiments, each defined validation category of the neighboring category subset is also in the related category subset if a shape descriptor data object of the defined validation category matches the shape descriptor object of the target validation category. A shape descriptor object may describe one or more shape-defining features of an object identifier associated with a corresponding validation category, such as a shape-defining feature that describes whether pills associated with a pill category are round, oblong, capsule, teardrops, and/or the like.

At step/operation 506, the computing system 100 combines the labeled production line images for each defined validation category in the related category subset (which also includes the labeled production line images for the target validation category itself that is in the related category subset) to generate the plurality of training production line images for the target validation category. In some embodiments, restricting the training set in this manner increases the efficacy of the categorical validation machine learning models to distinguish similar looking pills without increasing the training and runtime costs associated with the categorical validation machine learning models.

Returning to FIG. 4, at step/operation 402, the computing system 100 generates a plurality of transformed training production line images for the target validation category based on the plurality of training production line images for the target validation category. In some embodiments, one or more image transformation operations are applied on the plurality of transformed training production line images to generate the plurality of transformed training production line images. Examples of image transformation operations include crop operations, enhancement/normalization operations, and/or other operations described herein to generate a transformed image.

At step/operation 403, the computing system 100 performs one or more data augmentation operations on the transformed training production line images to update the transformed training production line images. In some embodiments, the data augmentation operations are configured to ensure that a subset of the transformed training production line images that includes the transformed images for the labeled production line images of a target validation category (i.e., those production line images that are deemed to depict production line items associated with the target validation category) satisfies a labeled image count threshold, e.g., is equal to or above a labeled image count threshold of 1000.

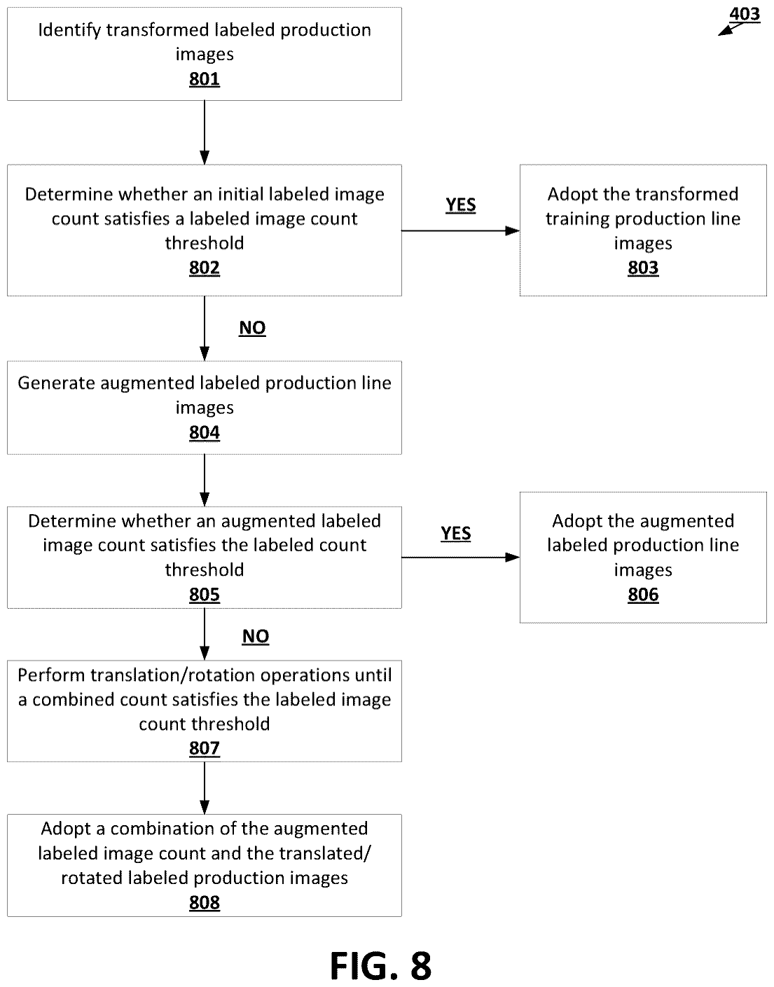

In some embodiments, step/operation 403 is performed in accordance with the process that is depicted in FIG. 8.

FIG. 8 is a flowchart diagram of an example process for performing one or more data augmentation operations on a set of transformed training production line images to update the set of transformed training production line images in accordance with some embodiments discussed herein. The process that is depicted in FIG. 8 begins at step/operation 801 when the computing system 100 identifies a set of transformed labeled production line images for the target validation category from the set of transformed training production line images. The set of transformed labeled production line images may include all of the transformed training production line images that are generated by applying image transformation operations on the labeled production line images for the target validation category. As described above, a labeled production line image for a validation category may be a production line image that is deemed to depict a production line item associated with the validation category.

At step/operation 802, the computing system 100 determines whether an initial labeled image count of the one or more transformed labeled training production line images satisfies (e.g., exceeds) a labeled image count threshold. The initial labeled image count may be the count of the one or more transformed labeled training production line images for the target validation category. An example of a labeled image count threshold is 1000.

At step/operation 803, in response to determining that the initial labeled image count satisfies the labeled image count threshold, the computing system 100 adopts the transformed training production line images without generating any new images. In some embodiments, because the initial labeled image count satisfies the labeled image count threshold, the computing system 100 is configured to skip generating new images as sufficient labeled images are deemed to exist among the transformed training production line images.

At step/operation 804, in response to determining that the initial labeled image count fails to satisfy the labeled image count threshold, the computing system 100 first performs one or more sliding window operations across each transformed labeled training production line image to generate a plurality of augmented labeled production line images. In some embodiments, the sliding window operations are defined by a sliding window of a specific size, such as a sliding window of 224×224 pixels. The augmented labeled production line images may either include both the transformed labeled production line images and the newly generated images generated using the sliding window operations, or may just include the latter.

At step/operation 805, in response to determining that the initial labeled image count fails to satisfy the labeled image count threshold, subsequent to step/operation 804, the computing system 100 determines whether an augmented labeled image count of the plurality of augmented labeled production line images satisfies the labeled image count threshold. The augmented labeled image count may describe the count of the augmented labeled production line images. An example of a labeled image count threshold is 1000.

At step/operation 806, in response to determining that the initial labeled image count fails to satisfy the labeled image count threshold, but the augmented labeled image count satisfies the labeled image count threshold, the computing system 100 adopts the augmented labeled production line images as the transformed training production line images. In some embodiments, because sliding window operations generated sufficient new images, the new images (either individually or along with the initial transformed training production line images) are adopted as the transformed training production line images used for training the categorical validation machine learning model.

At step/operation 807, in response to determining that the initial labeled image count fails to satisfy the labeled image count threshold and that the augmented labeled image count also fails to satisfy the labeled image count threshold, the computing system 100 performs one or more translation/rotation operations on the plurality of augmented labeled production line images to generate one or more translated/rotated labeled production line images until a combined count of the plurality of augmented labeled production line images and the one or more translated/rotated labeled production line images satisfies the labeled image count threshold. In some embodiments, as many iterations of an image translation/rotation routine are performed until a first iteration in which the combined count described above satisfies the labeled image count threshold. An example of a labeled image count threshold is 1000.

At step/operation 808, in response to determining that the initial labeled image count fails to satisfy the labeled image count threshold and the augmented labeled image count also fails to satisfy the labeled image count threshold, subsequent to step/operation 807, the computing system 100 generates the plurality of transformed training production line images based on the plurality of augmented labeled production line images and the one or more translated/rotated labeled production line images. In some embodiments, the computing system 100 combines the plurality of augmented labeled production line images and the one or more translated/rotated labeled production line images to generate the plurality of transformed training production line images.

Returning to FIG. 4, at step/operation 404, the computing system 100 generates the categorical validation machine learning model based on the plurality of transformed training production line images. In some embodiments, the categorical validation machine learning model corresponds to the machine learning detection model 302. In some embodiments, the computing system 100 trains the categorical validation machine learning model as a machine learning model that is configured to process feature data associated with an input production line image in order to generate a validation prediction about whether the input production line image is an image of a production line item associated with a corresponding target validation category.

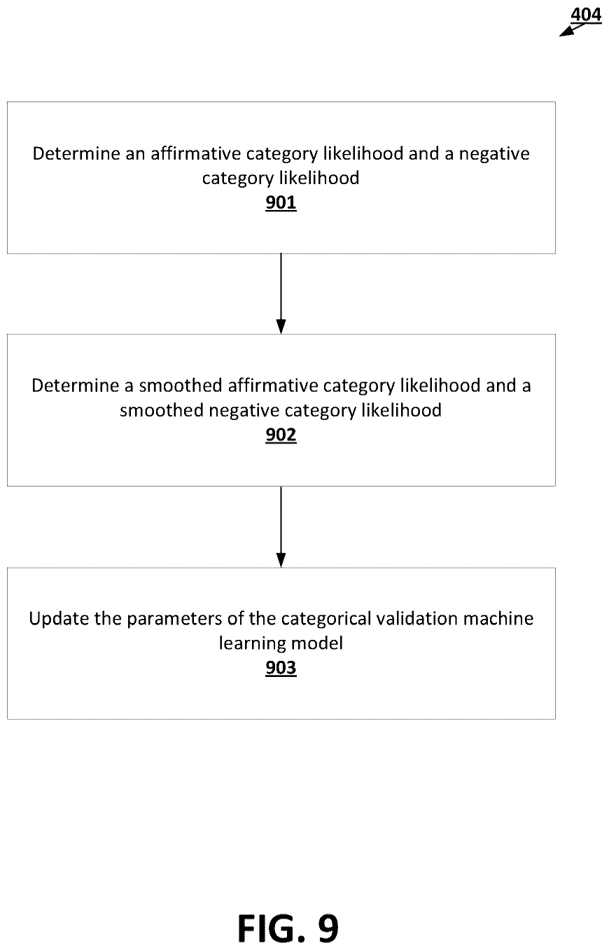

In some embodiments, step/operation 404 may be performed in accordance with the process that is depicted in FIG. 9.

FIG. 9 is a flowchart diagram of an example process for updating parameters of a categorical validation machine learning model based on a transformed training production line image in accordance with some embodiments discussed herein. The process that is depicted in FIG. 9 begins at step/operation 901 when the computing system 100 processes the training production line image using the categorical validation machine learning model to determine an affirmative category likelihood for the training production line image and a negative category likelihood for the training production line image. In some embodiments, processing the training production line image using the categorical validation machine learning model comprises processing extracted image-based features for the training production line image and one or more physical production attributes for the training production line image.

The affirmative category likelihood for the training production line image may describe a value generated by the categorical validation machine learning model that describes a likelihood that a production line image provided as an input to the categorical validation machine learning model (e.g., during training, a training production line image) corresponds to a validation category associated with the categorical validation machine learning model. The negative category likelihood for the training production line image may describe a value generated by the categorical validation machine learning model that describes a likelihood that a production line image provided as an input to the categorical validation machine learning model (e.g., during training, a training production line image) does not correspond to a validation category associated with the categorical validation machine learning model. In some embodiments, the affirmative category likelihood and the negative category likelihood are processed using a likelihood smoothing transformation to determine a smoothed affirmative likelihood and a smoothed negative category likelihood.

At step/operation 902, the computing system 100 processes the affirmative category likelihood and the negative category likelihood using a likelihood smoothing transformation to determine a smoothed affirmative likelihood and a smoothed negative category likelihood. The likelihood smoothing transformation may be configured to adjust the affirmative category likelihood and the negative category likelihood using class weights that represent expected likelihoods of observation of affirmative association of input production line images with the validation category for the categorical validation machine learning model and negative association of input production line images with the validation category for the categorical validation machine learning model. For example, the likelihood smoothing transformation may comprise a log function that apply logarithmic operations based on the noted class weights (e.g., with mu tuning for the noted log functions set to a defined value, such as to 0.15).

At step/operation 903, the computing system 100 updates the parameters of the categorical validation machine learning model based on the smoothed affirmative category likelihood and the smoothed negative category likelihood. In some embodiments, the parameters of the categorical validation machine learning model are updated in a manner that is configured to minimize a loss function determined based on a measure of deviation of the smoothed affirmative category likelihood and the smoothed negative category likelihood with a ground-truth label for the training production line image, where the ground-truth label describes whether the training production line image is associated with the validation category that is associated with the categorical validation machine learning model.

Once trained, categorical validation machine learning models enable efficiently and reliably performing conformance monitoring of a production line in order to determine defective/non-conformant production line items. By enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. By enabling the noted functionalities and associated advantages, various embodiments of the present disclosure reduce the operational load on production line control systems and thus improve the operational efficiency and the operational reliability of the noted production line control systems.

Turning now to FIG. 7B, illustrated is a dataflow diagram 750 related to one or more image cropping and/or image formatting processes for a production line image in accordance with some embodiments discussed herein. The dataflow diagram 750 includes the production line image 301. In some embodiments, the production line image 301 includes imagery related to a production line item such as, for example, a vial container that contains pills. In some embodiments, the image cropping process 350 determines an outer circumference 751 associated with the production line item. In some embodiments, the outer circumference 751 may correspond to an opening of the production line item (e.g., an opening of the vial container). Additionally, in some embodiments, the image cropping process 350 generates the cropped image 303 based on the outer circumference 751. In some embodiments, the image cropping process 350 utilizes the edge detection model 304 to determine the outer circumference 751. In some embodiments, the image cropping process 350 removes an exterior image portion 760 of the production line image 301 that is located outside the outer circumference 751.

In some embodiments, the image cropping process 352 generates the derivative cropped image 305 based on an interior circumference associated with the production line item. For example, the image cropping process 352 may remove an interior image portion 752 from the cropped image 303 to generate the derivative cropped image 305. The interior image portion 752 may be, for example, a center image portion of the cropped image 303. In some embodiments, a shape of the interior image portion 752 may correspond to a shape of the interior circumference associated with the production line item. For example, the interior image portion 752 may correspond to a circle shape. In some embodiments, the image cropping process 352 may identify the interior image portion 752 based on the one or more item attributes 310 (e.g., the shape data 310a, the curvature data 310b, and/or the object data 310c). For example, the image cropping process 352 may identify the interior image portion 752 based on a curvature of a bottom portion of the production line item, a number of objects within the production line item, a visual characteristic of the production line item, and/or a visual characteristic of an object within the production line item.

In some embodiments, the image formatting process 354 generates the transformed input image 307 from the derivative cropped image 305. In some embodiments, the image formatting process 354 generates the transformed input image 307 from the derivative cropped image 305 based on the one or more model parameters 312 of the machine learning detection model 302. Additionally or alternatively, in some embodiments, the image formatting process 354 generates the transformed input image 307 from the derivative cropped image 305 by using the geometric transfer function 320. In some embodiments, the derivative cropped image 305 may include an at least partially circular boundary and the transformed input image 307 may include an at least partially rectangular boundary. In some embodiments, the image formatting process 354 scales the rectangular boundary based on a model input size associated with the machine learning detection model 302. In some embodiments, the model input size is defined by a set of sliding window parameters associated with the machine learning detection model 302.

### Image Preprocessing and Machine Learning Operations

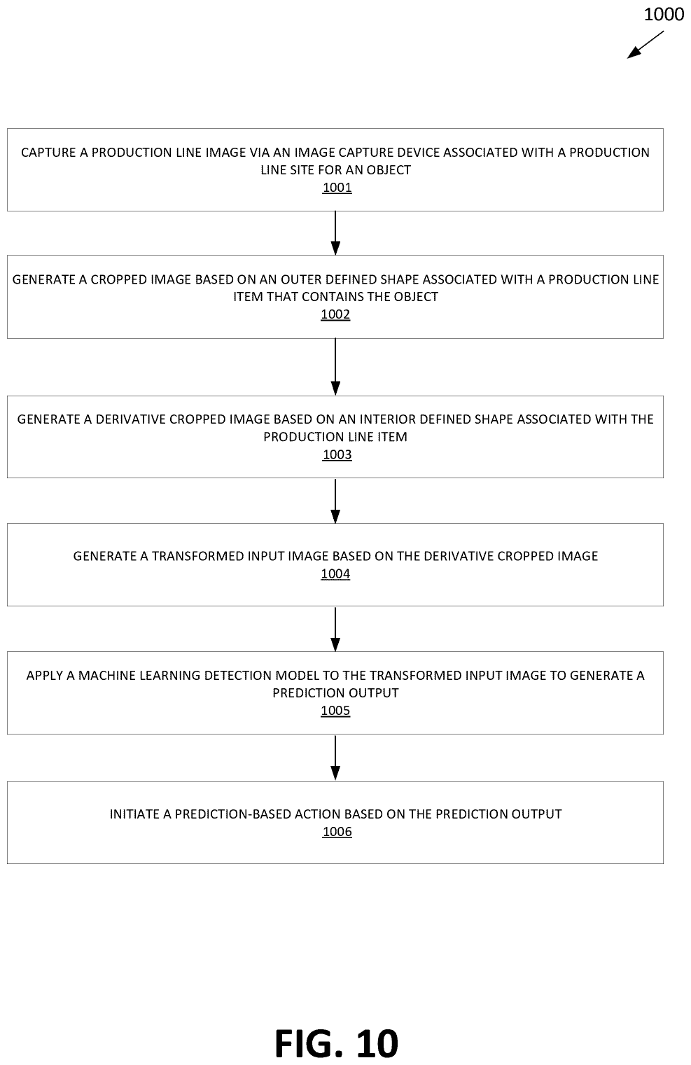

FIG. 10 is a flowchart showing an example process 1000 for selectively, intelligently, and optimally preprocessing data for a machine learning detection model in accordance with some embodiments discussed herein. The process 1000 may improve distribution operations within a distribution facility by intelligently adapting model input data for a machine learning detection model to different object attributes (e.g., a fill level, etc.). The process 1000 may be implemented by one or more computing devices, entities, and/or systems described herein. For example, via the various steps/operations of the process 1000, the computing system 100 may leverage improved training techniques to generate and automatically act on predictive insights tailored to individual machine learning models within a categorical validation ensemble model. By doing so, the process 1000 enables an improved automated routing processes within a distribution facility to improve the adaptability of facility throughput, while maintaining strict compliance standards.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes, at step/operation 1001, capturing a production line image via an image capture device associated with a production line site for an object. In some embodiments, the production line image is generated by an image capture device physically located at a production line site associated with a machine learning detection model.

In some embodiments, the process 1000 includes, at step/operation 1002, generate a cropped image based on an outer defined shape associated with a production line item that contains the object.

In some embodiments, the process 1000 includes, at step/operation 1003, generating a derivative cropped image based on an interior defined shape associated with the production line item.

In some embodiments, the process 1000 includes, at step/operation 1004, generating a transformed input image based on the derivative cropped image.

In some embodiments, the process 1000 includes, at step/operation 1005, applying a machine learning detection model to the transformed input image to generate a prediction output. In some embodiments, the machine learning detection model is a categorical validation machine learning model that provides a prediction with respect to a validation prediction. In some embodiments, the validation prediction is related to a fill level of a production line item. In some embodiments, the prediction output may correspond to a validation prediction for the production line image.

In some embodiments, the process 1000 includes, at step/operation 1006, initiating a prediction-based action based on the prediction output. In some embodiments, the prediction-based action may include one of one or more production line routing actions associated with a production line of a production line site corresponding to the site identifier.

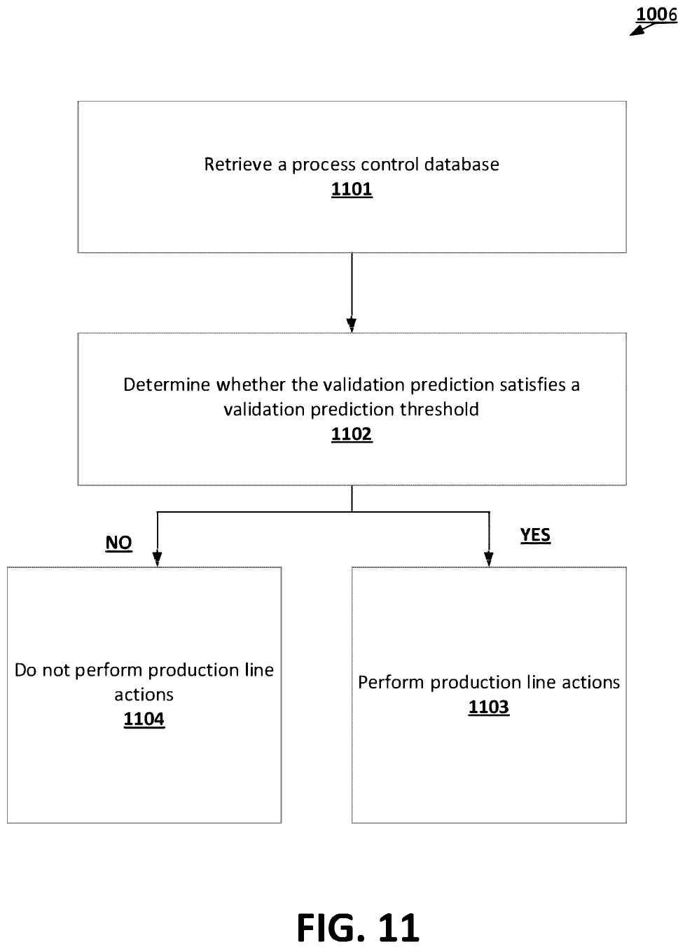

In some embodiments, step/operation 1006 may be performed in accordance with the process that is depicted in FIG. 11.

FIG. 11 is a flowchart diagram of an example process 1100 for performing one or more prediction-based actions based on a validation prediction for an input production line image with respect to a target validation category in accordance with some embodiments discussed herein. The process that is depicted in FIG. 11 may begin at step/operation 1101 when the computing system 100 receives a process control database that describes a validation prediction threshold for the validation category and one or more process control parameters for the validation category. The process control database may describe, for each validation category of a set of defined validation categories, the validation prediction threshold for the validation category and the one or more process control parameters for the validation category, where the validation prediction threshold for the validation category may describe a condition that, when satisfied by the validation prediction for a production image line image with respect to the validation category, causes performance of one or more production line control actions based on one or more process control parameters associated with the validation category.

For example, a prediction-based action may include one of one or more production line routing actions. In some examples, a prediction-based action may be identified from the one or more production line routing actions based on a comparison between the validation prediction and one or more action thresholds. For instance, the one or more production line routing actions may include (a) a clearance action associated with a clearance threshold, (b) a reimage action associated with a reimage threshold, (c) an image review action associated with a review threshold, and/or (d) a manual inspection action associated with an inspection threshold. In some examples, the clearance threshold, the reimage threshold, the review threshold, and/or the inspection threshold define a hierarchical threshold scheme.

At step/operation 1102, the computing system 100 determines whether the validation prediction satisfies a respective action threshold described by the process control database for the validation category. At step/operation 1103, in response to determining that the validation prediction satisfies the respective threshold, the computing system 100 may perform one or more one or more production line control actions based on one or more process control parameters associated with the validation category as described by the process control database. At step/operation 1104, in response to determining that the validation prediction fails to satisfy the validation prediction threshold, the computing system 100 may not perform the one or more production line control actions.

In some embodiments, performing the process control actions includes generating an action signal for the production line item associated with the production line image, such as generating an action signal on a commercial pharmacy production fill line after a pill bottle has been filled and imaged. The action signal may represent an exception signal, a no exception signal, an error signal, and/or the like. In some embodiments, an internet browser-based interface is provided to maintain and update values in the process control database. This interface may enable a pharmacy operations team to dynamically tune the number of exceptions produced for review by a human pharmacist as it allows them to change the thresholding parameters and rules that generate exceptions in near real time.

Accordingly, as described above, optimizing model input data for a machine learning detection model may enable efficiently and reliably performing conformance monitoring of a production line in order to determine defective/non-conformant production line items. By enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. By enabling the noted functionalities and associated advantages, various embodiments of the present disclosure reduce the operational load on production line control systems and thus improve the operational efficiency and the operational reliability of the noted production line control systems.

In some embodiments, after an initial evaluation of a production line item is completed, a proposed system and/or a human agent empties a pill bottle, then refills the pill bottle, and then repeats the evaluation. In some embodiments, one or more of the action thresholds described herein may be optimized using specific techniques including by using relative economics involved in the costs of a false positive and a false negative. In some embodiments, machine learning detection models may be retrained using evaluation results (e.g., model predictions and/or human evaluation results) to improve prediction results. In some embodiments, a proposed system evaluates crops of the same vial to detect foreign bodies or instances of incorrect pills in otherwise correctly filled pill bottles, and causes an exception when a “foreign object” (e.g., a loose screw from the machinery or a piece of lint) is detected in a production line image using a new exception type in addition to the exception types described above.

In some embodiments, performing the prediction-based actions comprises identifying a second input production line image of a production line item after emptying of the production line image and refilling of the production line image; determining a second validation determination based on the second production line image; and performing one or more second prediction-based actions based on the second validation prediction. In some embodiments, performing the prediction-based actions comprises determining a foreign object validation prediction for the input production line image; and determining whether to generate a foreign object exception based on the foreign object validation prediction. In some embodiments, performing the prediction-based actions comprises determining an incorrect pill validation prediction for the input production line image; and determining whether to generate an incorrect pill exception based on the incorrect pill validation prediction.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations depicted may be performed in parallel or in a different sequence that does not materially impact the function of the various examples. In other examples, different components of an example device or system that implements a particular example may perform functions at substantially the same time or in a specific sequence.

Example 1. A computer-implemented method comprising: generating, by one or more processors, a cropped image from a production line image based on an outer circumference associated with a production line item; generating, by the one or more processors, a derivative cropped image from the cropped image based on an interior circumference associated with the production line item; generating, by the one or more processors and by applying a geometric transformation function, a transformed input image from the derivative cropped image based on one or more model parameters of a machine learning detection model; generating, by the one or more processors and using the machine learning detection model, a prediction output based on the transformed input image; and initiating, by the one or more processors, the performance of one or more prediction-based actions based on the prediction output.

Example 2. The computer-implemented method of claim 1, wherein generating the cropped image of the production line image comprises: removing an exterior image portion of the production line image that is located outside the outer circumference associated with the production line item.

Example 3. The computer-implemented method of any of the preceding examples, further comprising: identifying, using an edge detection model, the outer circumference of the production line item within the production line image.

Example 4. The computer-implemented method of any of the preceding examples, wherein the production line item is a vial container and the outer circumference corresponds to an opening of the vial container.

Example 5. The computer-implemented method of any of the preceding examples, wherein generating the derivative cropped image of the production line image comprises: removing an interior image portion of the production line image that is located within the interior circumference associated with the production line item.

Example 6. The computer-implemented method of any of the preceding examples, further comprising: identifying the interior circumference of the production line item based on one or more item attributes of the production line item.

Example 7. The computer-implemented method of any of the preceding examples, wherein the one or more item attributes identify at least one of: (i) a curvature of a bottom portion of the production line item, (ii) a number of objects within the production line item, or (iii) a visual characteristic of the production line item or an object within the production line item.

Example 8. The computer-implemented method of any of the preceding examples, wherein the derivative cropped image comprises an at least partially circular boundary and the transformed input image comprises an at least partially rectangular boundary.

Example 9. The computer-implemented method of any of the preceding examples, wherein the at least partially rectangular boundary is scaled based on a model input size associated with the machine learning detection model.

Example 10. The computer-implemented method of any of the preceding examples, wherein the model input size is defined by a set of sliding window parameters.

Example 11. A computing system comprising memory and one or more processors communicatively coupled to the memory, the one or more processors configured to: generate a cropped image from a production line image based on an outer circumference associated with a production line item; generate a derivative cropped image from the cropped image based on an interior circumference associated with the production line item; generate, by applying a geometric transformation function, a transformed input image from the derivative cropped image based on one or more model parameters of a machine learning detection model; generate, using the machine learning detection model, a prediction output based on the transformed input image; and initiate the performance of one or more prediction-based actions based on the prediction output.

Example 12. The computing system of example 11, the one or more processors further configured to: remove an exterior image portion of the production line image that is located outside the outer circumference associated with the production line item.

Example 13. The computing system of any of the preceding examples, the one or more processors further configured to: identify, using an edge detection model, the outer circumference of the production line item within the production line image.

Example 14. The computing system of any of the preceding examples, wherein the production line item is a vial container and the outer circumference corresponds to an opening of the vial container.

Example 15. The computing system of any of the preceding examples, the one or more processors further configured to: remove an interior image portion of the production line image that is located within the interior circumference associated with the production line item.

Example 16. The computing system of any of the preceding examples, the one or more processors further configured to: identify the interior circumference of the production line item based on one or more item attributes of the production line item.

Example 17. The computing system of any of the preceding examples, wherein the one or more item attributes identify at least one of: (i) a curvature of a bottom portion of the production line item, (ii) a number of objects within the production line item, or (iii) a visual characteristic of the production line item or an object within the production line item.

Example 18. The computing system of any of the preceding examples, wherein the derivative cropped image comprises an at least partially circular boundary and the transformed input image comprises an at least partially rectangular boundary.

Example 19. The computing system of any of the preceding examples, wherein the at least partially rectangular boundary is scaled based on a model input size associated with the machine learning detection model.

Example 20. One or more non-transitory computer-readable storage media including instructions that, when executed by one or more processors, cause the one or more processors to: generate a cropped image from a production line image based on an outer circumference associated with a production line item; generate a derivative cropped image from the cropped image based on an interior circumference associated with the production line item; generate, by applying a geometric transformation function, a transformed input image from the derivative cropped image based on one or more model parameters of a machine learning detection model; generate, using the machine learning detection model, a prediction output based on the transformed input image; and initiate the performance of one or more prediction-based actions based on the prediction output.

1. A computer-implemented method comprising:
generating, by one or more processors, a cropped image from a production line image based on an outer circumference associated with a production line item;
generating, by the one or more processors, a derivative cropped image from the cropped image based on an interior circumference associated with the production line item;
generating, by the one or more processors and by applying a geometric transformation function, a transformed input image from the derivative cropped image based on one or more model parameters of a machine learning detection model;
generating, by the one or more processors and using the machine learning detection model, a prediction output based on the transformed input image; and
initiating, by the one or more processors, the performance of one or more prediction-based actions based on the prediction output.

2. The computer-implemented method of claim 1, wherein generating the cropped image of the production line image comprises:
removing an exterior image portion of the production line image that is located outside the outer circumference associated with the production line item.

3. The computer-implemented method of claim 1, further comprising:
identifying, using an edge detection model, the outer circumference of the production line item within the production line image.

4. The computer-implemented method of claim 1, wherein the production line item is a vial container and the outer circumference corresponds to an opening of the vial container.

5. The computer-implemented method of claim 1, wherein generating the derivative cropped image of the production line image comprises:
removing an interior image portion of the production line image that is located within the interior circumference associated with the production line item.

6. The computer-implemented method of claim 5, further comprising:
identifying the interior circumference of the production line item based on one or more item attributes of the production line item.

7. The computer-implemented method of claim 6, wherein the one or more item attributes identify at least one of: (i) a curvature of a bottom portion of the production line item, (ii) a number of objects within the production line item, or (iii) a visual characteristic of the production line item or an object within the production line item.

8. The computer-implemented method of claim 1, wherein the derivative cropped image comprises an at least partially circular boundary and the transformed input image comprises an at least partially rectangular boundary.

9. The computer-implemented method of claim 8, wherein the at least partially rectangular boundary is scaled based on a model input size associated with the machine learning detection model.

10. The computer-implemented method of claim 9, wherein the model input size is defined by a set of sliding window parameters.

11. A computing system comprising memory and one or more processors communicatively coupled to the memory, the one or more processors configured to:
generate a cropped image from a production line image based on an outer circumference associated with a production line item;
generate a derivative cropped image from the cropped image based on an interior circumference associated with the production line item;
generate, by applying a geometric transformation function, a transformed input image from the derivative cropped image based on one or more model parameters of a machine learning detection model;
generate, using the machine learning detection model, a prediction output based on the transformed input image; and
initiate the performance of one or more prediction-based actions based on the prediction output.

12. The computing system of claim 11, the one or more processors further configured to:
remove an exterior image portion of the production line image that is located outside the outer circumference associated with the production line item.

13. The computing system of claim 11, the one or more processors further configured to:
identify, using an edge detection model, the outer circumference of the production line item within the production line image.

14. The computing system of claim 11, wherein the production line item is a vial container and the outer circumference corresponds to an opening of the vial container.

15. The computing system of claim 11, the one or more processors further configured to:
remove an interior image portion of the production line image that is located within the interior circumference associated with the production line item.

16. The computing system of claim 15, the one or more processors further configured to:
identify the interior circumference of the production line item based on one or more item attributes of the production line item.

17. The computing system of claim 16, wherein the one or more item attributes identify at least one of: (i) a curvature of a bottom portion of the production line item, (ii) a number of objects within the production line item, or (iii) a visual characteristic of the production line item or an object within the production line item.

18. The computing system of claim 11, wherein the derivative cropped image comprises an at least partially circular boundary and the transformed input image comprises an at least partially rectangular boundary.

19. The computing system of claim 18, wherein the at least partially rectangular boundary is scaled based on a model input size associated with the machine learning detection model.

20. One or more non-transitory computer-readable storage media including instructions that, when executed by one or more processors, cause the one or more processors to:
generate a cropped image from a production line image based on an outer circumference associated with a production line item;
generate a derivative cropped image from the cropped image based on an interior circumference associated with the production line item;
generate, by applying a geometric transformation function, a transformed input image from the derivative cropped image based on one or more model parameters of a machine learning detection model;
generate, using the machine learning detection model, a prediction output based on the transformed input image; and
initiate the performance of one or more prediction-based actions based on the prediction output.
